(19) United States
(12) Patent Application Publication
(10) Pub. No.: US 2025/0278562 A1
(43) Pub. Date: Sep. 4, 2025

(54) Dynamic Audio Story Generation And Social Network

(71) Applicant: Treefort Media LLC, Los Angeles, CA (US)

(72) Inventors: Kelly GARNER, Los Angeles, CA (US); Oscar GUIDO, Glendate, CA (US); Thomas MONAHAN, Van Nuys, CA (US); Davie PAPWORTH, New Rochelle, NY (US)

(21) Appl. No.: 18/821,836

(22) Filed: Aug. 30, 2024

Related U.S. Application Data
(60) Provisional application No. 63/648,061, filed on May 15, 2024.
(60) Provisional application No. 63/561,223, filed on Mar. 4, 2024.

(51) Int. Cl. G06F 40/20; G06F 16/387; G10L 13/08

(52) U.S. Cl. CPC G06F 40/20; G06F 16/387; G10L 13/08

(57) ABSTRACT

A system for creating highly personalized stories can receive location information associated with a user, which can be used to help identify one or more points of interest (POIs). One of these POIs can be manually or automatically selected. A user can select or the system can auto-select a host, which can represent a personality (e.g., a true crime podcaster, a documentarian, a comedian, an art historian, and the like). The POI and host information can be used to generate a custom prompt that can be fed into a large language model (LLM) generative AI to generate an output used to create a story transcript. The story transcript and host information can then be fed into an audio synthesis engine to generate synthesized audio used to create story audio content. The story audio content and optionally the story transcript can then be presented to the user.

### CROSS-REFERENCE TO RELATED APPLICATIONS

The present application claims the benefit of U.S. Provisional Patent Application No. 63/648,061 filed May 15, 2024, and titled “Methods And Systems For Audio Processing And Display On A Social Network” and U.S. Provisional Patent Application No. 63/561,223 filed Mar. 4, 2024, and titled “Methods And Systems For Audio Processing And Display On A Social Network,” the disclosures of which are hereby incorporated by reference in their entirety.

### TECHNICAL FIELD

The present disclosure relates to content generation, and more specifically, to generating and presenting customized audio stories and related displays.

### BACKGROUND

Audio tours are useful tools to provide users with information about their surroundings. Often, users will purchase or otherwise obtain an audio tour for a specific location, such as a guided city tour, a museum tour, a nature tour, a zoo tour, and the like. The user can listen along as the audio tour takes them from stop to stop, providing information about whatever is located at the current stop. For example, in a museum tour, the audio tour can provide information about a series of exhibits which the user may access in a predefined order, or on demand (e.g., by keying in an appropriate identifier for a given exhibit).

Audio tours generally take the form of a set of pre-recorded messages, each of which is associated with a given stop in a set of predetermined stops. While such audio tours may be enjoyable for many, they are limited in scope by the pre-recorded messages and predetermined stops. Further, updating audio tours for any reason can be difficult or outright impossible in many circumstances. For example, if a stop is added, removed, or changed on a city tour, there may be difficulty in finding the original voice actor or a suitable replacement voice actor to provide updated audio content. Further, due to the expenses required to generate new audio tours using traditional means, cost-conscious organizations may be unable to generate useful audio tours and other organizations may be less inclined or able to produce updated or new audio tours. Additionally, whenever an audio tour is desired to be translated into a new language, significant expense and time is required to translate the text and then have a voice actor fluent in that language record the translated text.

There is a need for improved audio story technology to provide users with informative and/or entertaining audio stories. There is a need for improved audio story technology that encourages users to explore topics and/or locations. There is a need for improved audio story technology that lowers barriers to the creation of new, engaging audio stories. There is a need for improved audio story technology that can quickly provide an audio story in a new language not previously used for that audio story.

### BRIEF SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, supplemented by this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Embodiments of the present disclosure include a computer-implemented method, which includes receiving location information associated with a user, identifying one or more points of interest (POIs) based at least in part on the location information, dynamically generating story content based at least in part on the identified one or more POIs, and providing the story content for presentation to the user.

In some cases, dynamically generating the story content includes generating a story transcript based at least in part on the identified one or more POIs, and generating story audio content based at least in part on the story transcript. In some cases, receiving the location information includes receiving global positioning satellite (GPS) coordinates associated with a user device of the user, and determining the location information based at least in part on the GPS coordinates. In some cases, identifying the one or more POIs includes receiving a user POI selection indicative of at least one POI of the one or more POIs. The computer-implemented method may also include receiving one or more camera images associated with a user device of the user, where identifying the one or more POIs is based at least in part on the one or more camera images. The computer-implemented method may also include storing the dynamically generated story content for later use. In some cases, providing the story content for presentation to the user includes providing one or more follow-up prompts for presentation to the user following presentation of the story content.

The computer-implemented method may also include receiving a story host selection, where generating the story transcript is further based at least in part on the story host selection, and where generating the story audio content is further based at least in part on the story host selection. In some cases, the story host selection is indicative of a story theme and a voice identifier, where generating the story transcript includes preparing a custom prompt based at least in part on the identified one or more POIs and the story theme, passing the custom prompt to a large language model (LLM) generative artificial intelligence (AI), and receiving an AI response from the LLM generative AI, the story transcript being based at least in part on the AI response; and where generating the story audio content includes passing the voice identifier and the story transcript to an artificial intelligence (AI) audio synthesis engine and receiving synthesized audio in response to passing the voice identifier and the story transcript, the story audio content being based at least in part on the synthesized audio.

In some cases, generating the story transcript includes preparing a custom prompt based at least in part on the identified one or more POIs, passing the custom prompt to a large language model (LLM) generative artificial intelligence (AI), and receiving an AI response from the LLM generative AI, the story transcript being based at least in part on the AI response. In some cases, preparing the custom prompt is further based at least in part on one or more preferences associated with the user. In some cases, preparing the custom prompt includes selecting a prompt template from a plurality of prompt templates, and the custom prompt is based at least in part on the selected prompt template. In some cases, the location information includes a location name, and preparing the custom prompt is further based at least in part on the location name.

The computer-implemented method may also include identifying one or more advertisement vendors associated with the location information or the one or more POIs, where preparing the custom prompt is based at least in part on the one or more advertisement vendors such that the AI response includes content associated with the one or more advertisement vendors. The computer-implemented method may also include identifying one or more advertisements associated with the location information or the one or more POIs, where generating the story transcript includes combining the one or more advertisements with at least a portion of the AI response to create the story transcript.

In some cases, generating the story audio content includes receiving a voice identifier, passing the voice identifier and the story transcript to an artificial intelligence (AI) audio synthesis engine, and receiving synthesized audio in response to passing the voice identifier and the story transcript, the story audio content being based at least in part on the synthesized audio. The computer-implemented method may also include identifying one or more audio advertisements associated with the location information or the one or more POIs, where generating the story audio content includes combining the one or more audio advertisements with at least a portion of the synthesized audio to create the story audio content.

The computer-implemented method may also include generating a shareable uniform resource locator (URL) associated with the stored story content, where the URL, when accessed by an additional user, causes the stored story content to be provided to the additional user.

Embodiments of the present disclosure include a system includes a control system including one or more processors, and a memory having stored thereon machine readable instructions, where the control system is coupled to the memory, and any of the methods disclosed above is implemented when the machine executable instructions in the memory are executed by at least one of the one or more processors of the control system.

Embodiments of the present disclosure include a computer program product embodied on a non-transitory computer-readable medium and includes instructions which, when executed by a computer, cause the computer to carry out any of the methods disclosed above.

Other technical features may be readily apparent to one skilled in the art from the following figures, descriptions, and claims.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a story generation and sharing ecosystem, according to certain aspects of the present disclosure.

FIG. 2 is a flowchart depicting a process for dynamically generating story content, according to certain aspects of the present disclosure.

FIG. 3 is a flowchart depicting a process for dynamically generating a story transcript, according to certain aspects of the present disclosure.

FIG. 4 is a flowchart depicting a process for dynamically generating story audio content, according to certain aspects of the present disclosure.

FIG. 5 is a flowchart depicting a process for encouraging follow-up interactions, according to certain aspects of the present disclosure.

FIG. 6 is a chart depicting a story content generation workflow, according to certain aspects of the present disclosure.

FIG. 7 is a chart depicting a follow-up content generation workflow, according to certain aspects of the present disclosure.

FIG. 8 is a chart depicting a social interaction workflow and a story management workflow, according to certain aspects of the present disclosure.

FIG. 9 is a set of screenshots depicting graphical user interfaces (GUIs) for general startup and POI selection, according to certain aspects of the present disclosure.

FIG. 10 is a screenshot depicting an alternate GUI for POI selection, according to certain aspects of the present disclosure.

FIG. 11 is a set of screenshots depicting GUIs for story playback, activity information, and user preferences, according to certain aspects of the present disclosure.

FIG. 12A is a portion of a diagram depicting available story hosts, according to certain aspects of the present disclosure.

FIG. 12B is a continuation portion of the diagram of FIG. 12A.

FIG. 12C is a continuation portion of the diagram of FIG. 12B.

FIG. 13A is a set of screenshots depicting GUIs for host selection and initial POI selection, according to certain aspects of the present disclosure.

FIG. 13B is a continuation of the screenshots of FIG. 13A.

FIG. 14 is a set of screenshots depicting GUIs for social interactions, according to certain aspects of the present disclosure.

FIG. 15A, is a portion of a diagram depicting GUI screens for story host selection, according to certain aspects of the present disclosure.

FIG. 15B is a continuation portion of the diagram of FIG. 15A.

FIG. 15C is a continuation portion of the diagram of FIG. 15B.

FIG. 15D is a continuation portion of the diagram of FIG. 15C.

FIG. 15E is a continuation portion of the diagram of FIG. 15D.

FIG. 16 is a set of screenshots depicting GUIs for social interaction, according to certain aspects of the present disclosure.

FIG. 17 is a block diagram of an example system architecture for implementing features and processes of the present disclosure.

### DETAILED DESCRIPTION

Certain aspects and features of the present disclosure relate to creating highly personalized stories, such as audio stories. A system can receive location information associated with a user, such as from a user device (e.g., a mobile phone or tablet). The location information can be used to help identify one or more points of interest (POIs). In some cases, user input can be used to select a particular POI, or a POI can be automatically selected by the system through a “surprise me” function. In some cases, a user can select or the system can auto-select a host, which can represent a personality (e.g., a true crime podcaster, a documentarian, a comedian, an art historian, and the like). The POI and host information can be used to generate a custom prompt that can be fed into a large language model (LLM) generative AI to generate an output used to create a story transcript. The story transcript and host information can then be fed into an audio synthesis engine to generate synthesized audio used to create story audio content. The story audio content and optionally the story transcript can then be presented to the user. After completion of the story, the user can be presented with one or more follow-up prompts based on the POI used to generate the story or the story transcript itself (e.g., based on POIs mentioned in the story).

As used herein, the term story is intended to include short or long narrations in text form, non-text visual form (e.g., icons and rebuses), and/or audio form. Generally, however, the term story will take the form of a short narration in audio form, often accompanied by a transcript in text form. Stories can be fictional (e.g., imaginative tales) or non-fictional (e.g., news articles, architectural descriptions, sports facts, etc.).

Each story can be associated with a particular location or POI. A POI can be any suitable point of interest, such as buildings, businesses, intersections, natural features, human-made features, neighborhoods, regions, cities, states, countries, and the like. As used herein, the term location is intended to refer to a particular geolocation, which can be associated with (e.g., can include) a single POI or multiple POIs. In some cases, the term POI can be inclusive of an individual associated with a particular location. For example, when nearby the birthplace of Edgard Allen Poe, “Edgard Allen Poe” may be considered a POI and may be selectable for story generation.

A collection of stories can be referred to as a tour. A user may engage the tour by going to the various locations associated with the stories in the tour and listening to or reading the appropriate story for each location. For example, a tour may be created for a museum by identifying multiple POIs within the museum and generating stories, as disclosed in further detail herein, for each of those POIs.

Location information can include a geolocation (e.g., GPS coordinates) and optionally a location name or other identifying information. In some cases, when GPS coordinates are known, the system can access an appropriate application programming interface (API) or other resource to determine the location name from the GPS coordinates.

The location information can be used to determine one or more POIs associated with that location, such as via geolocation or via location name. In some cases, multiple potential POIs can be identified, such as all POIs within a threshold distance of the user's current geolocation or identified as being located at the location name. In some cases, at least some of the potential POIs can be displayed to a user to give the user an option to select one of the potential POIs for subsequent story generation. In some cases, a user may elect to use an auto-select feature (e.g., a “surprise me” feature) that will automatically select, from the potential POIs, a POI for subsequent story generation. The auto-select feature can be random, pseudo-random, or non-random. In some cases, the auto-select feature can select a POI based on certain criteria, such as the POI nearest the user's geolocation, the POI previously identified by the user as being of interest (e.g., saved to a wish list), the POI most frequented by other users, the POI having a highest rating or score (e.g., a real-world rating of the POI itself, such as a restaurant rating, or a rating of stories generated from the POI, such as user-provided ratings after listening to a story generated from that POI).

Once a POI is selected, it can be used to generate a custom prompt that can be passed to an LLM generative AI to output an AI response that is usable to create the story transcript. In some cases, the AI response itself is used as the story transcript, although that need not always be the case. For example, advertisements or other information may be combined with the AI response to create the final story transcript. The custom prompt can be based on the POI and optionally additional factors, such as a host selection and/or user preferences.

As used herein, the term host is intended to refer to a persona used to define certain parameters for story generation. Hosts can be entirely fictional, can be based on a real-life persona (e.g., a fictional persona designed to have some similar traits of a human individual), and/or can be representative of a human individual (e.g., a host that is based on a celebrity's persona and uses a voice synthesizer trained using that celebrity's voice). Each host can define multiple parameters, such as a genre (e.g., news, comedy, society & culture, business, true crime, sports, religion and spirituality, arts, government, etc.) and a voice identifier. In some cases, available hosts can be provided in a list. In some cases, users (e.g., all users or users with specific permissions) can create their own hosts, such as by providing their own genre label, their own custom prompt template information (e.g., a prompt template or information for using/modifying an existing prompt template), and/or their own voice identifier.

The genre of a selected host can be used in the creation of the custom prompt. For example, when a true crime host is selected, the custom prompt may be something like “describe, like a true crime podcaster, information about any crimes that have been committed at or within the vicinity of <the POI>, or otherwise relating to <the POI>,” where <the POI> is intended to be replaced by the name of the selected POI. However, when a food critic host is selected, the custom prompt may be something like “write a 150-200 word review of the restaurant at <the POI> including information about the quality and selection of their food, an average price per meal, and bathroom accommodations.”

A custom prompt can be generated by leveraging the POI (e.g., an official or common name of the POI), the host selection (e.g., a genre and/or persona associated with the selected host), and other optional information (e.g., user preferences, such as preference for shorter or longer stories or preference for less complex vocabulary). Generating the custom prompt can include selecting a prompt template for use (e.g., selected based on information about the POI, such as whether the POI is a city, a building, or a business; on information about the host, such as a genre and/or personality associated with the host; and optionally on other information, such as user preferences. In some cases, each host is associated with a particular prompt template.

Once a story transcript is generated, it can be provided to an audio synthesis engine to generate audio based on the story transcript. The audio synthesis engine can take text as input and output audio content, such as music, sound effects, or voice content. Generally, the audio synthesis engine can be designed to output only voice content, although that need not always be the case. The audio synthesis engine can be embodied across one or more systems and/or one or more APIs. In some cases, the text provided as input to the audio synthesis engine can be used to define the style of voice used for voice content. In some cases, however, a specific vocal identifier can be passed to the audio synthesis engine to have the audio synthesis engine generate the voice content in the appropriate voice. In such an example, the audio synthesis engine may make use of many different audio synthesis models, each one associated with a particular voice identifier. Voice identifiers can be in any form or format, such as identification numbers, alphanumeric strings, voice names, and the like. For example, a selected host may be associated with a voice identifier “Fred” in which case passing the story transcript and the voice identifier to the audio synthesis engine would result in an output audio file of the “Fred” voice reading the story transcript. In some cases, language information is passed to the audio synthesis engine to ensure the output is in the proper language.

Language information can be passed in the form of a unique preference (e.g., an indication for English, Spanish, French, etc.). In some cases, however, the language information is inherent in the voice identifier, as the voice associated with the voice identifier may itself be inherently associated with a particular language (e.g., “Fred” may be associated with English, “Federico” may be associated with Spanish, and “Frédéric” may be associated with French). As used herein, the term language with reference to synthesizing audio is intended to include (i) differentiating between languages (e.g., English, Spanish, French); and/or (ii) differentiating between subsets or dialects of languages (e.g., English—American, English—British, Spanish—Peninsular, Spanish—Americas).

The output of the audio synthesis engine can be referred to as synthesized audio. In some cases, the synthesized audio itself is used as the story audio content, although that need not always be the case. For example, audio advertisements or other audio content may be combined with the synthesized audio to create the final story audio content.

The story audio content and/or the story transcript can be provided for presentation to the user, such as via a mobile app. In some cases, the story audio content and/or the story transcript, optionally along with any inputs used to generate the story audio content and/or the story transcript, can be stored for later use.

In some cases, the user can select a host prior to selecting a POI and the system can automatically generate a list of relevant POIs from the list of all available POIs. For example, when selecting a host associated with arts, the system may identify, from the list of all available POIs, those POIs that are likely to be related to arts, such as museums, buildings with murals, and the like.

In some cases, a user can provide feedback for a story, such as to identify one or more ratings (e.g., overall enjoyment rating, story quality rating, voice quality rating, etc.), to identify one or more factual inaccuracies (e.g., hallucinations from the LLM generative AI), to provide additional information (e.g., photographs of the POI), and/or the like.

In some cases, story generation can occur for multiple POIs In some cases, story generation for multiple POIs can take the form of sequential story generation, in which case unique stories are generated for each POI. In some cases, however, story generation for multiple POIs can take the form of combination story generation, in which case a story can be generated that is based on multiple POIs. In an example, a user may select three buildings along a street as desired POIs. In such an example, sequential story generation would involve performing story generation for each POI individually (e.g., by creating custom prompts for each POI), resulting in three separate stories. However, if combination story generation were used, the three POIs can be used in combination to generate a single prompt which can be fed to an LLM generative AI to ultimately create a single story transcript. Such a combination story transcript might discuss a topic common to the three POIs and/or may discuss and/or compare information about the three POIs. For example, an architectural-style story generated on three buildings may compare and contrast the different architectural features of the three buildings with one another.

Certain aspects and features of the present disclosure are especially useful for improving the fields of story generation and tour generation, at least by allowing for on-demand generation of new story transcripts and new story audio content for POIs. Further, certain aspects and features of the present disclosure facilitate the creation of new, location-based, creative content (e.g., story transcripts and story audio content), which can be presented to a user and/or further leveraged for other purposes. Additionally, the use of follow-up prompts based on the POI or story transcript from a prior story enable a new way to engage with one's surroundings, such as by selecting an initial nearby POI and then going down “rabbit holes” of recursive, related POIs.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

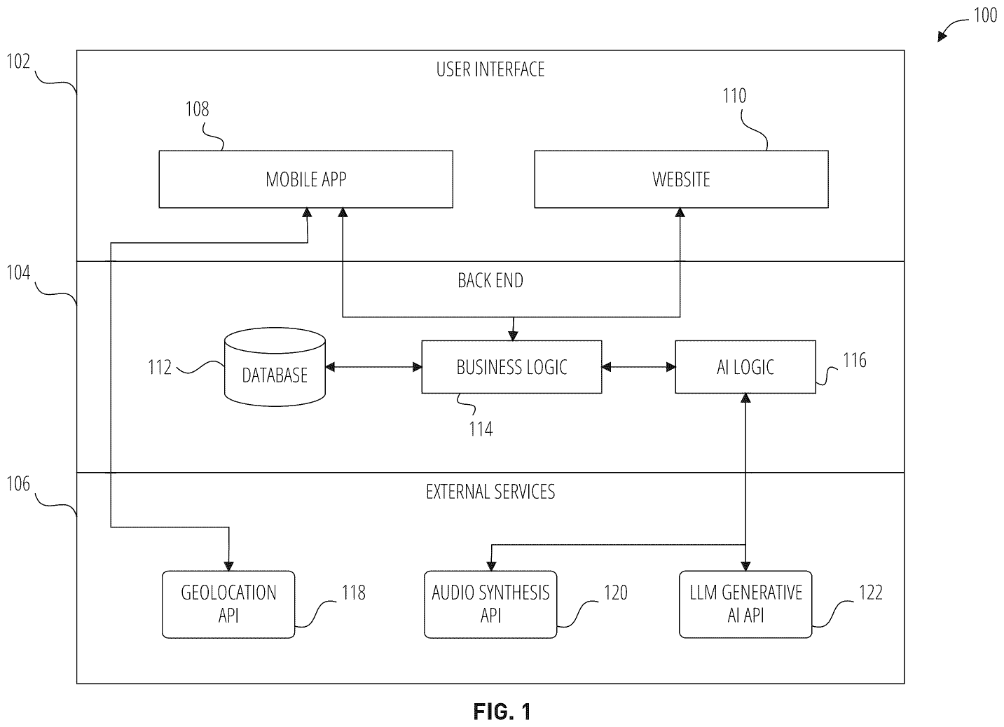

FIG. 1 is a block diagram depicting a story generation and sharing system 100, according to certain aspects of the present disclosure. The story generation and sharing system 100 includes a user interface 102 (e.g., a frontend) and a back end 104. The user interface 102 and/or the back end 104 communicates with external services 106 to perform various functions. The external services 106 can be considered to form part of the story generation and sharing system 100 (e.g., when the external services 106 are implemented together along with the back end 104) or to be separate from the story generation and sharing system 100 (e.g., when a first organization implements the back end 104 and third-party organizations implement the external services 106).

The story generation and sharing system 100 can be implemented on one or more computing devices (e.g., personal computers, smartphones, tablets, servers, etc.) located in one or more locations. Generally, the user interface 102 will operate on (e.g., be presented on and receive user input from) a user device (e.g., a smartphone, tablet, personal computer). Often, the user device will be a mobile device that permits the user to easily engage the user interface 102 at various locations.

The mobile app 108 is an application (e.g., a native application or web application) that interfaces with the back end 104 and/or the external services 106 to perform various functions. The mobile app 108 receives user input, such as in the form of tapping on buttons or icons, entering text, acquiring camera images, or the like; and provides output to the user, such as in the form of a graphical user interface or audio playback.

In some cases, the user interface 102 can include a website 110 accessible from a user device. The website 110 can perform some or all of the functions of the mobile app 108, or different functions. For example, the website 110 can provide an interface designed more to allow users to identify POIs via manual searching while the mobile app 108 can provide an interface designed more to allow users to identify POIs via one or more sensors of the user device (e.g., a GPS receiver to acquire GPS coordinates, a camera to obtain photographs of a POI).

In some cases, the user interface 102 can handle initiating requests to the back end 104, such as requests to generate a story, and receiving responses to such requests, such as to start playback of a generated story. In some cases, the user interface 102 can handle initiating requests to external services 106 and receiving responses to such requests, such as to identify a location name from GPS coordinates via a geolocation API 118 (e.g., the Google® Places API).

The back end 104 can be responsible for handling exchanges with the user interface 102 and various external services 106, as well as handling other logic. The back end 104 can include a database 112, a business logic 114 component, and an AI logic 116 component. The database 112 can store various types of information, such as information about hosts, information about users, information about POIs, previously generated stories, and the like. The database 112 can include a collection of prompt templates.

The business logic 114 component can receive a story generation request from the user interface 102 and can process the request to determine what information from the database 112 is to be used (e.g., what prompt template to use, what host to use, etc.). The business logic 114 can then pass the information to the AI logic 116 component, which can compile the custom prompt (e.g., using the prompt template and optionally information associated with the host, such as a genre). The AI logic 116 can then send the custom prompt to one or more of the external services 106, such as to the LLM generative AI API 122 (e.g., OpenAI™ API, AWS® Bedrock® API, etc.). The LLM generative AI API 122 can generate an AI response that is sent back to the AI logic 116. The AI logic 116 can then use that AI response as a story transcript or to generate a story transcript. The AI logic 116 can send the story transcript to another of the external services 106, such as to the audio synthesis API 120 (e.g., ElvenLabs™ API). As used herein, the audio synthesis API 120 can be referred to as an audio synthesis engine. The audio synthesis API 120 can use the story transcript to generate synthesized audio (e.g., synthesized speech) which can be provided back to the AI logic 116. The AI logic 116 can use the synthesized audio as story audio content itself or to generate story audio content. The AI logic 116 can provide the story audio content and/or the story transcript to the business logic 114, which can then communicate the story audio content and/or the story transcript to the user interface 102 for presentation to a user.

While described as separate APIs as part of external services 106, in some cases some of the functions of the external services 106 can be implemented as part of the back end 104 itself. While described with certain components, in some cases, a story generation and sharing system 100 can include fewer components, addition components, and/or different components. In some cases, the user interface 102, the back end 104, and each of the external services 106 can be implemented using their own computing environments, although that need not always be the case.

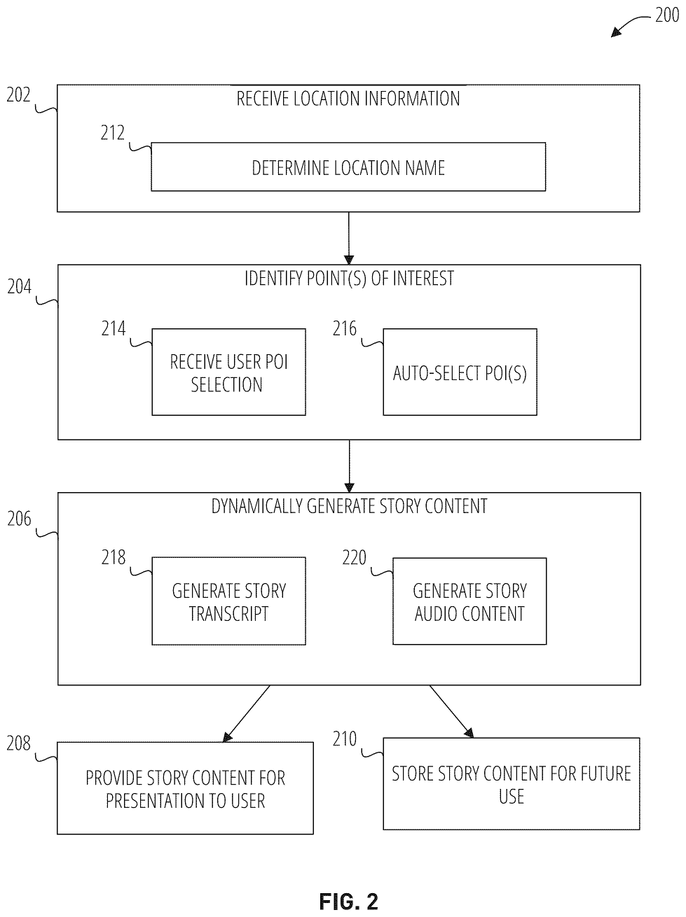

FIG. 2 is a flowchart depicting a process 200 for dynamically generating story content, according to certain aspects of the present disclosure. Various blocks of process 200 can occur in realtime or near realtime, allowing for realtime or near realtime generation of story content.

At block 202, location information is received. Location information can include raw location information (e.g., GPS coordinates) or processed location information (e.g., a location name). In some cases, determining location information at block 202 can include determining a location name at block 212. A location name can be a colloquial or easily readable identifier for a location, such as a business name or a street address. In some cases, determining a location name at block 212 can include using GPS coordinates (e.g., as obtained from a GPS sensor (e.g., GPS receiver) of a mobile device) to determine the location name. In such cases, the GPS coordinates can be supplied to a geolocation API (e.g., geolocation API 118 of FIG. 1), which can identify that location(s) are associated with those GPS coordinates. In some cases, determining a location name at block 212 can include using other sensor data, such as one or more digital camera images, to identify a location name. In such cases, the digital camera images can be provided to an appropriate API capable of returning a location name based on one or more digital images (e.g., an image classifier API).

At block 204, one or more POIs can be identified. Location information from block 202 can be used to identify one or more POIs or a set of available POIs. The available POIs can be presented to a user for selection. In some cases, the available POIs can be filtered based on preset or user-set options (e.g., only show the top 5 results within 0.5 miles of the user).

Identifying a POI at block 204 can include receiving a user POI selection at block 214 indicating a particular POI or set of POIs to use. For example, when presented with a list of available POIs or a map with icons representing available POIs, the user may tap on the desired POI(s) to make a selection. In some other cases, identifying one or more POIs can be performed automatically at block 216 by auto-selecting POIs. For example, a user can tap a “surprise me” button after which the system can select (e.g., randomly, pseudo-randomly, or non-randomly) one or more POI(s) from the available POIs.

At block 206, story content can be dynamically generated. Dynamically generating story content can include generating a story transcript at block 218 and/or generating story audio content at block 220. The story content can be generating using the identified POI(s) from block 204, and optionally additional information (e.g., location information from block 202, host information, user preferences, etc.). At block 218, a custom prompt can be generated using at least the identified POI(s) from block 204 and optionally other information (e.g., host information). The custom prompt can be provided to an LLM generative AI, which can then output an AI response. The AI response can be used as the story transcript or can be used to generate the story transcript (e.g., by inserting content at the beginning of, at the end of, or within the AI response). For example, in some cases the AI response can be combined with advertising content associated with the POI(s) used to generate the AI response. In some cases, such advertising content can be selected as being directly associated with a POI (e.g., an advertisement that is advertising services provided by the POI), being nearby the POI (e.g., an advertisement for a business located within walking distance of the POI), being associated with a topic that is related to the POI (e.g., an advertisement for an art supply store when visiting a POI that is an art gallery, or an advertisement for an online authorized reseller of sports clothing when the POI is a professional sports venue), or the like.

At block 220, the story transcript from block 218 can be provided to an audio synthesis engine to generate synthesized audio. The audio synthesis engine can be a voice synthesizer capable of generating realistic, human-sounding synthetic voices in multiple voices, optionally across multiple languages. The voice synthesizer can make use of many different text-to-speech AI models to provide different voices. In some cases, a voice may be entirely synthesized without association to a single individual. In some cases, however, a voice can be a cloned voice intended to clone the speech of an individual, such as a celebrity. In some cases, an audio synthesis engine can include synthesizers capable of generating non-voice audio content, such as sound effects and music. For example, generating the story audio content at block 220 may include initially generating synthesized speech using the story transcript, then generating synthesized music and/or sound effects using the synthesized speech and/or story transcript as input, all of which can be combined to generate synthesized audio that contains the synthesized speech in addition to synthesized music and/or sound effects. In an example of generating synthesized audio for a true-crime-podcast-style story, the synthesized audio may have intro and outro music, audio narration, and musical stings at especially intense parts of the story. The synthesized audio can be used as the story audio content itself, or can be used to generate the story audio content (e.g., by inserting content at the beginning of, at the end of, or within the synthesized audio). For example, in some cases the synthesized audio can be combined with audio advertisements (e.g., pre-recorded advertising audio content or separately synthesized advertising audio content) associated with the POI(s) used to generate the story transcript. Audio advertisements can be selected similarly to or the same as how advertisements are selected as described above with reference to generating a story transcript at block 218.

Then, the story transcript from block 218 and/or the story audio content from block 220 can be provided as story content at block 208. Providing the story content can include transmitting the story transcript and/or story audio content to a user interface (e.g., user interface 102 of FIG. 1) running on a user device.

In some cases, the story content at be stored for future use at block 210. In some cases, storing the story content can include storing any of the information used to generate the story content, such as location information from block 202, POI(s) from block 204, and/or other information (e.g., host information, user information, etc.). The stored story content can be associated with a shareable URL, thus allowing a user to share the generated story content with other users. In some cases, the stored story content can be re-used or made available when other users attempt to generate a story with the same inputs (e.g., the same POI(s) and the same host), although that need not always be the case.

While process 200 is described with reference to various blocks in a particular order, in some cases process 200 can include additional blocks, fewer blocks, and/or different blocks, in the same or different orders. For example, in some cases, process 200 may include an additional block between block 202 and block 206 for receiving a host selection from the user. In some cases, some blocks can be merged together or split into additional blocks.

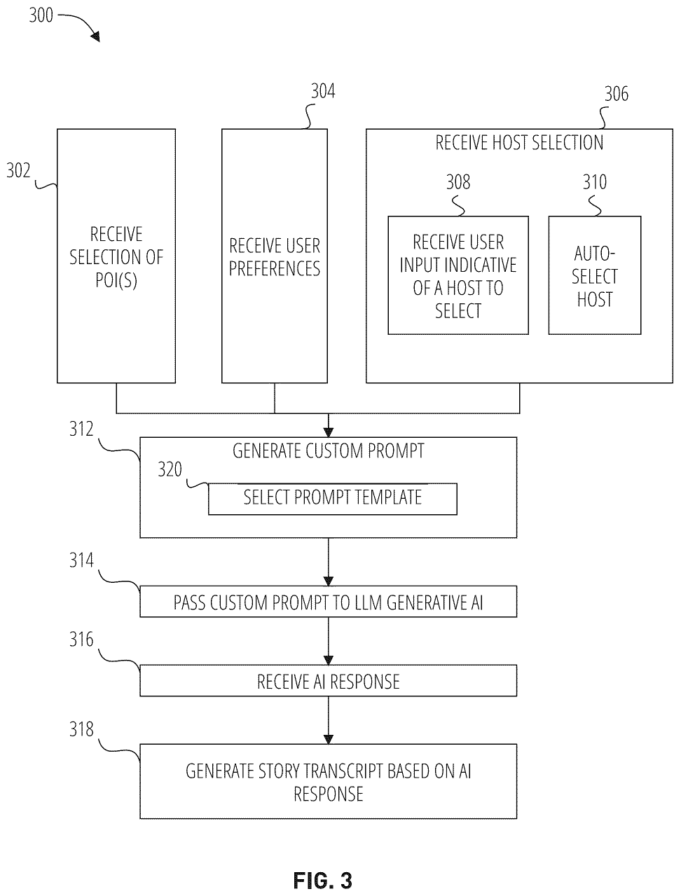

FIG. 3 is a flowchart depicting a process 300 for dynamically generating a story transcript, according to certain aspects of the present disclosure. Process 300 can be performed on any suitable computing device or set of computing devices, such as a backend server.

At block 302, a selection of POIs are received. In some cases, the selection of POIs can include a single POI, although in other cases multiple POIs can be received at once. Receiving a POI can include receiving a POI name, a POI location or address, a POI description, or any other suitable a POI identifier (e.g., an identification number or a link to a website associated with the POI). Often, receiving the POI includes receiving a POI name, such as a common name used to refer to the POI (e.g., for a business, the doing-business-as name; for an intersection, a colloquial name for the intersection or the names of the intersecting streets; for a building, the address or the building name).

At block 304, user preferences are received. Any suitable user preferences can be used to tailor the generation of the story. A user preference can be any suitable preference used to affect generation of the custom prompt. For example, a user preference for a particular language may affect how a custom prompt is generated at block 312 such that the custom prompt leads to a response in the preferred language (e.g., by including in the prompt a request for the response to be in that language, or by translating the entire prompt into that language prior to passing it to the LLM generative AI). As another example, a user preference may be indicative of one or more preferred genres (e.g., true crime, documentary, comedy, etc.). Such a genre preference may be used to narrow down appropriate POIs as part of or prior to block 302 (e.g., only show to the user POIs that would be applicable to the user's preferred genre(s)) and/or narrow down appropriate hosts as part of or prior to block 306 (e.g., only show hosts or auto-select from hosts that fit with the user's preferred genre(s)). However, in some cases, the genre preference can be used to alter generation of the custom prompt separately from how a POI and/or a host is used in the generation of a custom prompt. In such an example, a documentary host may be selected for generation of a documentary story on a selected POI, but user preferences may indicate one or more additional preferred genres (e.g., comedy and architecture), in which case the custom prompt that is generated can primarily emphasize the documentary genre, but also mention the additional preferred genre(s) (e.g., “Prepare a script for a documentary about the Washington Monument with extra focus on its architecture, in a comedic tone”).

At block 306, a host selection is received. Receiving the host selection can include receiving information identifying a host to use, which can include a host name, a host identifier (e.g., a number or an alphanumeric identifier), a host description (e.g., “a host with a calm and friendly female voice who focuses primarily on architectural features of buildings”), or the like. The host selection can be used to inform custom prompt generation. Each host can be associated with certain host information defining how the host affects generation of a story, including creation of the custom prompt and/or generation of synthesized audio. In some cases, this host information can include one or more genres (e.g., host “Candice” may be associated with a true crime genre, while host “Stephen” may be associated with monsterology and cryptozoology genres). The genre can be used to inform custom prompt generation such that the proper script is created based on that host's genre(s).

In some cases, host information can be used to indicate a particular style of presentation, which can affect generation of the story transcript and/or generation of the story audio content. A style of presentation can include any primarily non-substantive attributes of a story, such as the general tone of the story, the types of words used, the cadence of the story, and the like. Examples of different styles include academic, salesy, compassionate, strict, freeform, motivational, training, friendly, distant, flat, and the like.

In some cases, host information can include a voice identifier indicative of a particular voice to use when generating the synthesized audio. The voice identifier can be any suitable identifier, such as a voice name, an identification number or alphanumeric code, a voice description (e.g., a deep gravelly voice), or the like. The voice identifier can be passed to an audio synthesis engine as disclosed in further detail herein, which audio synthesis engine can use to choose the proper voice for generating the synthesized audio from the story transcript.

In some cases, receiving a host selection at block 306 can include receiving user input indicative of a host to select at block 308. Receiving this user input can include receiving a selection of a host or a selection of criteria used to identify a particular host. In some cases, receiving this user input can be in response to presenting a list of available hosts to the user. In some cases, the list of available hosts can be filtered such that only desired hosts are presented to the user for selection. Such filtering can occur automatically, such as to filter out hosts that are not in the user's language (e.g., as identified in the user's preferences) or to filter out hosts that the user does not have permissions to access (e.g., hosts requiring a subscription or prior purchase that the user does not yet have). Filtering can occur manually, such as by allowing the user to select criteria (e.g., sex, genre, style, etc.), which can be used to identify a subset of the available voices, which can be presented to the user for user selection).

In some cases, receiving a host selection at block 306 can include auto-selecting a host at block 310. Auto-selecting a host can occur in response to a user input indicative of the user desiring for auto-selection (e.g., tapping an “auto-select host” button) or automatically (e.g., automatically selecting a host by default unless the user decides otherwise). Auto-selecting a host can include accessing criteria used to filter the full list of available hosts into a list of potential hosts. A host can then be selected from the list of potential hosts randomly, pseudo-randomly, or non-randomly (e.g., selecting the host most often used by the user in the past, the host least often used by the user in the past, the host most often used by others, the host having a highest rating, and the like).

At block 312, a custom prompt is generated. Generation of a custom prompt can use the POI(s) from block 302, the host selection from block 306, and optionally other information, such as user preferences from block 304. Generating a custom prompt can include leveraging a prompt template to generate a prompt. An example of a basic prompt template could be “Write out a transcript for a spoken-word <<genre>> about <POI>,” where <genre> is a genre associated with the host selected at block 306 and <POI> is a POI selected at block 302. In such an example, if the genre was “historical documentary” and the POI is “Central Park,” the custom prompt based on the prompt template may be “Write out a transcript for a spoken-word historical documentary about Central Park.” More complex prompt templates can be used.

In some cases, generating the custom prompt at block 312 includes selecting a prompt template at block 320. Selecting a prompt template can include selecting a prompt template from a collection of potential prompt templates (e.g., a database of prompt templates) based on desired criteria. In some cases, each prompt template will be associated with a particular criterion, such that the POI selected at block 302 and/or the host selected at block 306 can be used to identify a particular prompt template to use. For example, each genre can be associated with a particular prompt template in the database of prompt templates, such that a genre of “comedy’ may result in selection of a first prompt template and a genre of “documentary” may result in selection of a second prompt template. The first prompt template can be written to be especially useful for generating stories of the “comedy” genre (e.g., “Write out a transcript for a spoken-word presentation about <POI> in a friendly and humorous tone, incorporating several short jokes or puns while still providing information about <POI>”), whereas the second prompt template can be written to be especially useful for generating stories of the “documentary” genre (e.g., “Write out a transcript for a spoken-word documentary about <POI>, focusing on a few interesting facts about <POI> that are easy to understand”). In another example, the number of POIs selected can be used as a criterion (e.g., a first prompt template is used when a single POI is selected, but a second prompt template is used when multiple POIs are selected). In another example, different prompt templates can be used for different types of POIs, such as using a first prompt template for restaurants and a second prompt template for museums. Various other criteria can be used in prompt template selection. In some cases, selection of a prompt template can include single-user or multi-user rating information about the prompt template, which can be based one or more ratings of past stories that were generated using that prompt template. For example, if a particular user seems to prefer (e.g., based on user-provided feedback or contextual feedback, such as whether or not the user finishes the whole store and/or whether or not the user replays the story) stories that were generated using one or more particular prompt templates, selecting the prompt template at block 320 can take that preference into account and select a suitable prompt template that is the same as or similar to that one or more particular prompt templates.

At block 314, the custom prompt from block 312 is passed to an LLM generative AI. Any suitable LLM generative AI can be used. The LLM generative AI can be trained to generate an AI response in response to receiving an input prompt. By using the custom prompt from block 312 as the input prompt, an AI response can be generated by the LLM generative AI and then received at block 316. In some cases, the LLM generative AI can be implemented by a third party, in which case passing the custom prompt to the LLM generative AI at block 314 may include accessing an API associated with the LLM generative AI to enable use of the LLM generative AI.

At block 318 a story transcript is generated based on the AI response from block 316. In some cases, generating the story transcript is as simple as using the AI response as the story transcript. In some cases, generating the story transcript includes applying simple post-processing to the AI response, such as to remove unnecessary, non-substantive content. In some cases, generating the story transcript can include incorporating additional content into the AI response. For example, additional content can include user-specific content (e.g., adding starting text saying “Hi John” or the like), host-specific content, advertising content, or the like. In an example, when generating a story transcript for a particular POI, a determination can be made that a particular piece of advertising content (e.g., a textual advertisement) should be used (e.g., because the advertising content is associated with the POI) and that piece of advertising content can be combined with the AI response to generate the story transcript (e.g., by adding the advertising content before, after, or within the AI response). After generation, the story transcript can be used as described herein, such as delivery to a user device for presentation to a user and/or in the generation of story audio content.

While process 300 is described with reference to various blocks in a particular order, in some cases process 300 can include additional blocks, fewer blocks, and/or different blocks, in the same or different orders. For example, in some cases, process 300 may not include block 304, in which case generating the custom prompt at block 312 occurs without need to access user preferences. In another example, process 300 may not include block 306, in which case generating the custom prompt at block 312 will occur with a pre-selected or default host without needing to receive a host selection. In another example, instead of passing a custom prompt to an LLM generative AI at block 314, the custom prompt can be passed to a different type of generative AI. In some cases, some blocks can be merged together or split into additional blocks.

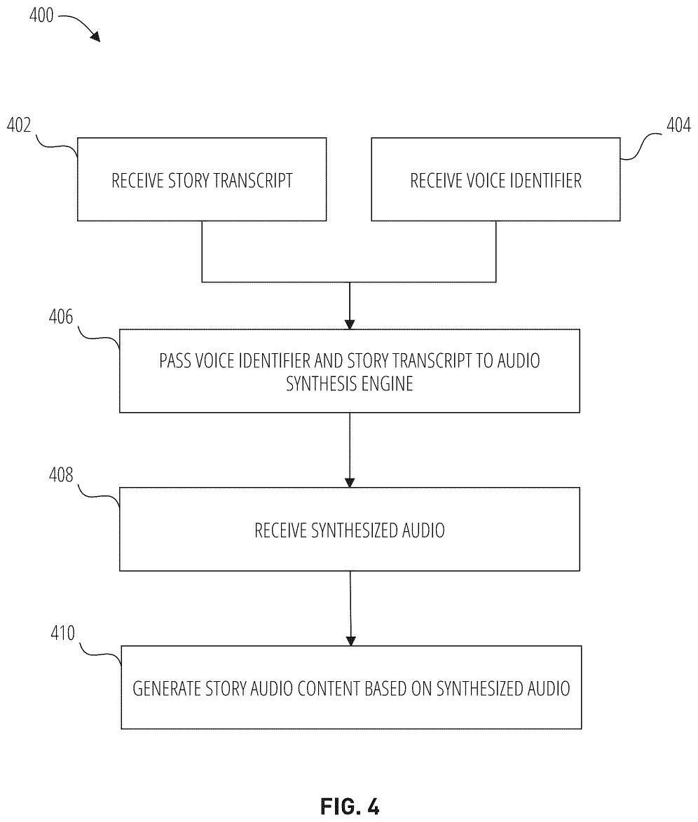

FIG. 4 is a flowchart depicting a process 400 for dynamically generating story audio content, according to certain aspects of the present disclosure. Process 400 can be performed on any suitable computing device or set of computing devices, such as a backend server.

At block 402, a story transcript is received. The story transcript can be the story transcript generated by process 300 of FIG. 3.

At block 404, a voice identifier can be received. In some cases, receiving a voice identifier at block 404 can include receiving a voice identifier associated with the selected host from block 306 of process 300 of FIG. 3. In some cases, receiving a voice identifier at block 404 can include selecting a default voice. In some cases, receiving a voice identifier at block 404 can include otherwise receiving a voice identifier, such as via direct user input (e.g., presenting the user with available voices separate from host selection). Each voice identifier can indicate a particular voice to be used by the audio synthesis engine.

At block 406, the voice identifier and the story transcript are passed to an audio synthesis engine. In some cases, the audio synthesis engine is implemented by a third-party, in which case the voice identifier and story transcript may be passed via an API associated with the audio synthesis engine. The audio synthesis engine can be any text-to-speech engine. In some cases, however, the audio synthesis engine is an AI-based text-to-speech engine trained on human voices and capable of producing human-like speech. In response to passing the voice identifier and story transcript to the audio synthesis engine, the audio synthesis engine can generate synthesized audio of the story transcript, as read by the voice associated with the provided voice identifier.

At block 408, the synthesized audio from the audio synthesis engine can be received. At block 410, story audio content can be generated based on the synthesized audio. In some cases, generating the story audio content is as simple as using the synthesized audio as the story audio content. In some cases, generating the story audio content includes applying simple post-processing to the synthesized audio, such as to change encoding, remove unnecessary, non-substantive content, or otherwise process the audio file. In some cases, generating the story audio content can include incorporating additional content into the synthesized audio. For example, additional content can include user-specific content, host-specific content (e.g., adding a starting phrase that is always used with the selected host, such as “Hi, I'm Sarah” or the like), advertising content, or the like. In an example, when generating story audio content for a particular POI, a determination can be made that a particular piece of advertising content (e.g., a pre-recorded advertisement) should be used (e.g., because the advertising content is associated with the POI) and that piece of advertising content can be combined with the synthesized audio to generate the story audio content (e.g., by adding the advertising content before, after, or within the story audio content). After generation, the story audio content can be used as described herein, such as delivery to a user device for presentation to a user and/or storage for future use.

While process 400 is described with reference to various blocks in a particular order, in some cases process 400 can include additional blocks, fewer blocks, and/or different blocks, in the same or different orders. For example, in some cases, process 400 may not include block 404, in which case no voice identifier is provided, so the audio synthesis engine may use a random, pseudorandom, or default voice to generate the synthesized audio. In some cases, some blocks can be merged together or split into additional blocks.

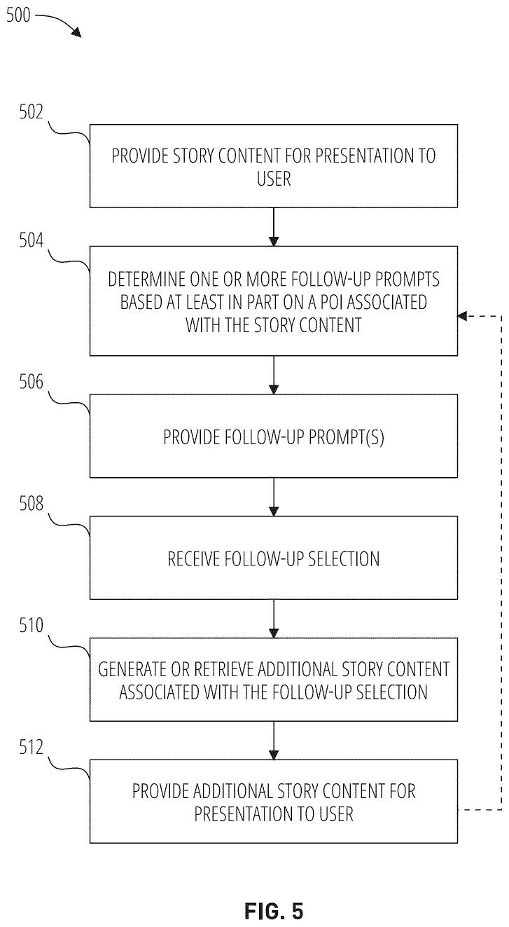

FIG. 5 is a flowchart depicting a process 500 for encouraging follow-up interactions, according to certain aspects of the present disclosure.

At block 502, story content can be provided for presentation to the user. The story content can include a story transcript (e.g., a story transcript from process 300 of FIG. 3) and/or story audio content (e.g., story audio content from process 400 of FIG. 4). Providing the story content for presentation to a user can include transmitting the story content to a user device associated with the user or otherwise making the story content available to the user. Story content can include a story transcript (e.g., a text-based), story audio content (e.g., a text-to-speech synthesized audio file of a story transcript), story-related images or videos (e.g., images or videos of the POI, images or videos of advertising content related to the POI, etc.), and the like.

In some cases, providing story content for presentation to a user can include automatically presenting the story content to the user. In some cases, providing story content for presentation can include transmitting the story content to a user device for presentation at a later time. Presentation of story content can include presenting the story content through any suitable display device (e.g., smartphone screen), audio device (e.g., earphones or headphones), or the like.

At block 504, one or more follow-up prompts can be determined. A follow-up prompt is suggestion that can be presented to a user for a subsequent story that the user may enjoy. A follow-up prompt may take the form of a button or set of buttons identifying other POIs that are suggested for the user, although that need not always be the case. The use of follow-up prompts suggesting one or more additional POIs for story generation allows a user to build a chain of stories. In some cases, by following the follow-up prompts, a user can learn about new places and things that they previously did not know about.

The follow-up prompt(s) can be based on a POI associated with the story content (e.g., associated with the POI itself or with a location of the POI). The follow-up prompts can give the user an option to request a story that is based on a POI related to the original POI, based on a POI that is related to the location of the original POI, or a POI otherwise related to the original POI. In some cases, the follow-up prompt can further be based on a selected genre (e.g., based on the selected host), such that suggested stories will purposefully have the same genre, or in some optional cases, purposefully have a different genre, than the genre of the initial story content.

In a first example, after presenting story content to a user that is an architectural history of a first POI that is a particular building in a city, the system may determine that a desirable follow-up prompt would be a prompt suggesting a second POI that is a different building in the city, possibly one with similar or contrasting architecture to the building of the first POI.

In a second example, after presenting story content to a user about a first POI that is a restaurant, the system may determine that desirable follow-up prompts would be prompts suggesting POIs that are other restaurants located nearby the first POI.

At block 506, the follow-up prompt(s) from block 504 can be provided for presentation to a user. For example, the follow-up prompt(s) can be transmitted to a user device for immediate or future presentation to a user. In some cases, providing the follow-up prompt can include providing the follow-up prompt during presentation of a story and/or after completion of a story. In some cases, however, providing a follow-up prompt can occur at the same time as delivery of the story content from which it is based. In some such cases, the follow-up prompt can be included as a separate part of the story content (e.g., the story content would include the story transcript, the story audio content, and the follow-up prompts). In some cases, the one or more follow-up prompts can be incorporated into the story transcript and/or story audio content (e.g., after the main content related to the POI is discussed, the story transcript and/or story audio content can include “After ceasing to use the Patent Office Building at F and 7th in 1932, the United States Patent Office moved to the Herbert Hoover Building for the next 37 years. Press the button below for more information about the Herbert Hoover Building.”).

At block 508, a follow-up selection can be received. The follow-up selection can be a selection made by the user based on the follow-up prompt. For example, if a follow-up prompt is provided that indicates a particular suggested POI, the follow-up selection can be a transmission initiated by the user indicating that the user wishes to proceed with the POI suggested in the follow-up prompt. In some cases, the follow-up selection is simply a new request to generate story content associated with the suggested POI. In some cases, the follow-up selection can be indicative of multiple POIs, such as indicating a first POI that should be initially played next and a second POI that should be played after the first POI (e.g., added to the chain after the first POI) or that should be saved for a future listening session (e.g., added to a “saved” or “wish list” list of POIs).

At block 510, additional story content is generated or retrieved in response to receiving the follow-up selection. The additional story content can be associated with a particular POI, namely the suggested POI from the follow-up prompt selected by the user. Generation of the additional story content can occur similarly to generation of initial story content for an initial POI, but using the suggested POI instead of the initial POI. In some cases, however, story content for the suggested POI may be already stored, in which case the system can merely retrieve the stored additional story content.

At block 512, the additional story content can be provided for presentation to the user. Providing the additional story content at block 512 can occur the same as or similarly to providing the initial story content at block 502, but with the additional story content instead of the initial story content.

In some cases, process 500 can continue iteratively from block 512 to block 504 to generate chains of stories. In some cases, the chain of stories can be stored for display (e.g., for a user to display to other users the chain they listened to recently) or other future uses (e.g., for a user to share a particular chain of stories with another user). The chain of stories can act as a sort of playlist for story content. In some cases, a user can edit a chain by deleting, adding, or moving stories in the chain.

While process 500 is described with reference to various blocks in a particular order, in some cases process 500 can include additional blocks, fewer blocks, and/or different blocks, in the same or different orders. In some cases, some blocks can be merged together or split into additional blocks. For example, in some cases when a follow-up prompt is included with the story content, block 504 can occur prior to block 502, and block 502 can be merged with block 506. In another example, block 506 can proceed automatically to block 510 without block 508, such as if the user enables an “autoplay” feature, in which case after a follow-up prompt is presented, the system can automatically proceed, such as after a short delay, with generating and presenting story content for the POI suggested in the follow-up prompt unless the user cancels the action.

In another example, instead of relying on follow-up prompts, a user can initiate a follow-up request by asking a question or otherwise indicating a desire for more information on the given POI or a different POI. In such cases, block 504 and block 506 can be removed and the follow-up selection from block 508 can be a follow-up request that was initiated by the user.

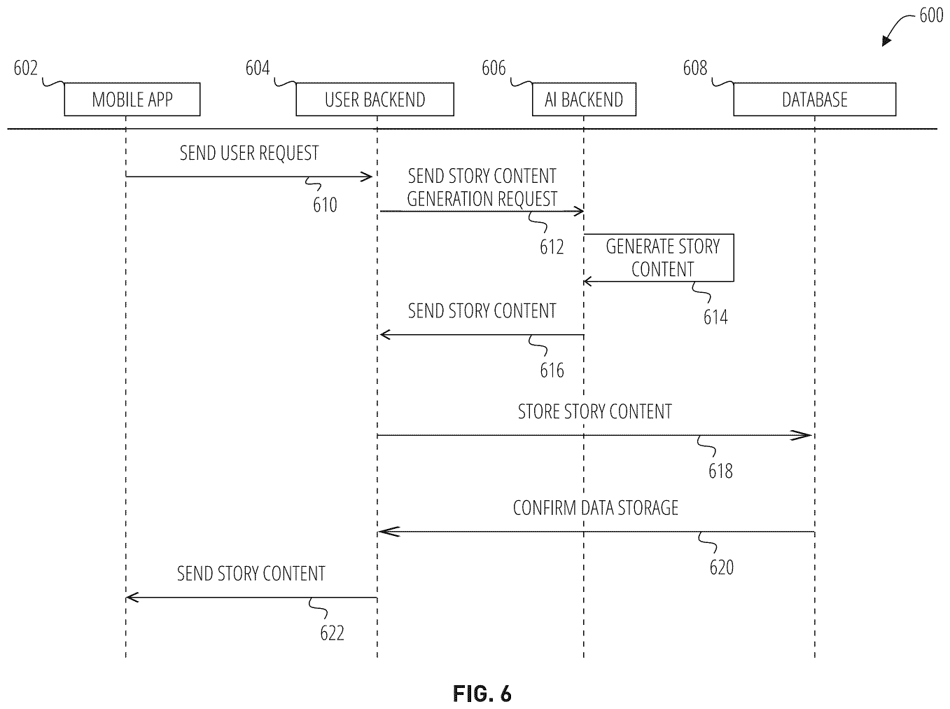

FIG. 6 is a chart depicting a story content generation workflow 600, according to certain aspects of the present disclosure. The story content generation workflow 600 can proceed the same as or similarly to process 300 of FIG. 3.

The story content generation workflow 600 shows actions between a mobile app 602 (e.g., running on a user device), a user backend 604 (e.g., running on a first server), an AI backend 606 (e.g., running on the first server or a second server), and a database 608 (e.g., communicatively coupled to the user backend 604).

Initially, the mobile app 602 can send communication 610, which can be a user request containing various information usable to generate story content. For example, the user request can include an identifier associated with the user, host selection information, POI selection information, and optional user preferences.

Upon receiving the communication 610, the user backend 604 can create a custom prompt (e.g., by selecting a prompt template and generating the custom prompt) and send, to the AI backend 606, a communication 612 that is a story content generation request. The story content generation request can include the custom prompt and any other information needed by the AI backend 606 to generate the story content (e.g., a voice identifier).

Upon receiving the communication 612, the AI backend 606 can generate story content at action 614. Generating the story content at action 614 can include sending a communication from the AI backend 606 to one or more other servers (not depicted) via one or more APIs as disclosed in further detail herein. For example, the AI backend 606 can send a communication that includes the custom prompt to a first AI server, which, upon receiving the custom prompt, generates an AI response and sends it back to the AI backend 606. The AI backend 606 can generate the story transcript from the AI response. The AI backend 606 can send a second communication that includes the story transcript to a second AI server, which, upon receiving the story transcript, generates synthesized audio and sends it back to the AI backend 606. The AI backend 606 can generate story audio content from the synthesized audio. The AI backend 606 can generate (e.g., compile) story content from the story transcript and the story audio content. The AI backend 606 can then send the story content to the user backend 604 by sending communication 616 to the user backend 604.

The user backend 604 can optionally store the received story content by sending a communication 618 to the database 608 that includes the story content and optionally other metadata (e.g., inputs and/or prompt used to generate the story content). The database 608 can store the story content for future use. In some cases, the database 608 can send communication 620 back to user backend 604 as a confirmation that the data has been stored.

The user backend 604, in response to communication 616, can send the story content to the mobile app 602 via communication 622. Once received, the story content can be automatically presented and/or optionally stored for future use.

While described with certain features and communications, story content generation workflow 600 may include additional, fewer, and/or different features and communications. For example, in some cases the user backend 604 and AI backend 606 can be integrated together, thus eliminating the need for communication 612 and communication 616. In another example, the communication 612 can be split into multiple communications, such as a first communication for the story transcript and a second communication for the story audio content.

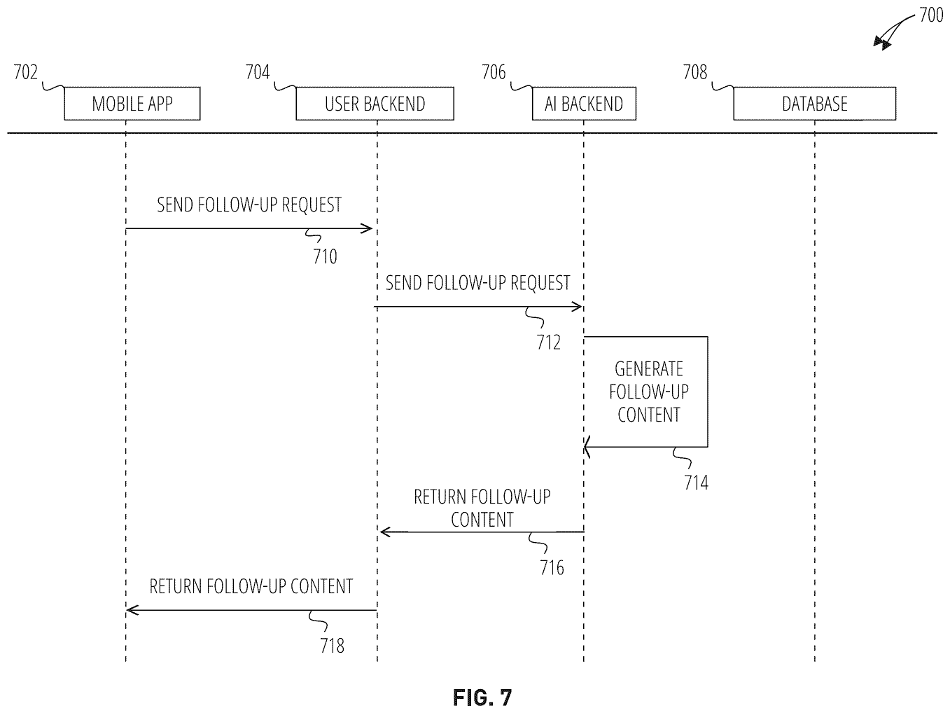

FIG. 7 is a chart depicting a follow-up content generation workflow 700, according to certain aspects of the present disclosure. The story follow-up content generation workflow 700 can proceed similarly to process 500 of FIG. 5 when a follow-up request is initiated by the user.

The story follow-up content generation workflow 700 shows actions between a mobile app 702 (e.g., running on a user device), a user backend 704 (e.g., running on a first server), an AI backend 706 (e.g., running on the first server or a second server), and a database 708 (e.g., communicatively coupled to the user backend 704).

The mobile app 702 can receive input form the user indicative of a request for more information. For example, the user may tap an interactive button, may type in a question, may speak a question, or may otherwise interact with the mobile app 702 to determine a request for more information. The mobile app 702 can send this follow-up request to the user backend 704 via communication 710.

The follow-up request can be a user-initiated request (e.g., created entirely by the user) or a follow-up selection (e.g., a selection of POIs made in response to a follow-up prompt).

The user backend 704, upon receiving the communication 710, can send a follow-up request to the AI backend 706 via communication 712. In some cases, the user backend 704 can convert the follow-up request as sent via the mobile app 702 into a format that is more understandable or usable for generation of follow-up content. For example, in some cases the user backend 704 can select a prompt template and generate a custom prompt using the follow-up request.

The AI backend 706 can generate, at action 714, follow-up content similarly to how it generates initial story content, such as described with reference to AI backend 606 of FIG. 6 but using the follow-up request from the user backend 704. Once the follow-up content is generated, the AI backend 706 can sent it to the user backend 704 via communication 716.

Upon receiving the communication 716, the user backend 704 can transmit the follow-up content to the mobile app 702 via communication 718. Once received, the follow-up content can be automatically presented and/or optionally stored for future use.

While described with certain features and communications, follow-up content generation workflow 700 may include additional, fewer, and/or different features and communications. For example, in some cases the user backend 704 and AI backend 706 can be integrated together, thus eliminating the need for communication 712 and communication 716. In another example, upon receiving the communication 716, the user backend 704 can optionally send the follow-up content to the database 708 via a communication. The database 708 can then optionally send a response back to the user backend 704 indicating that the follow-up content was stored. In some cases, follow-up content can be stored in association with the story content from which it originated.

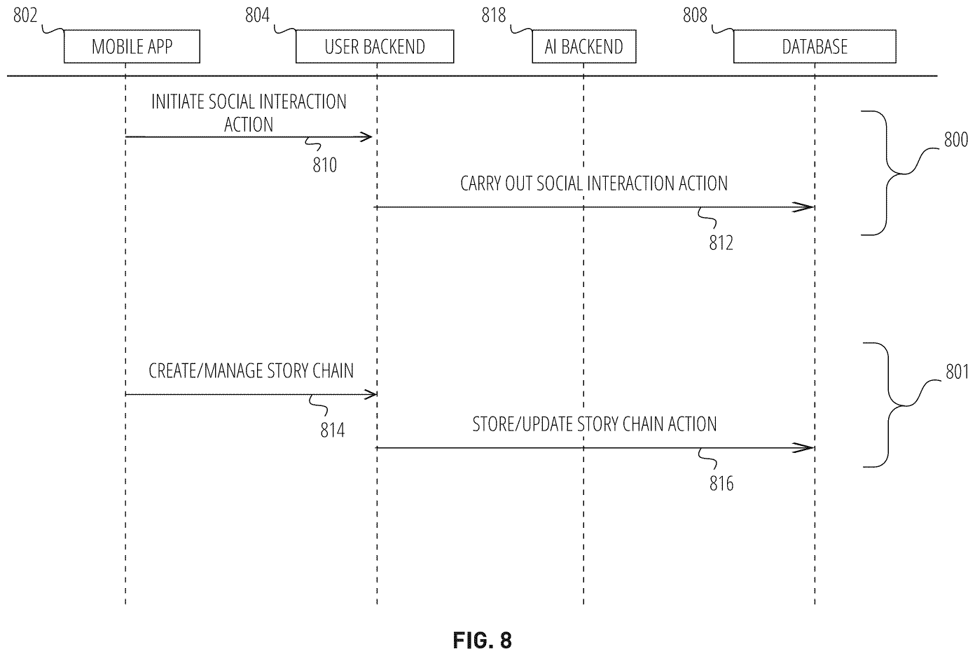

FIG. 8 is a chart depicting a social interaction workflow 800 and a story chain management workflow 801, according to certain aspects of the present disclosure.

In some cases, the system can include social features, such as the ability to post and share stories that one has generated, the ability to curate chains or playlists of stories, the ability to comment on another's posts or stories, the ability to suggest edits or corrections to story content (e.g., edits to story transcripts to correct an AI hallucinations or edits to story audio content to correct mispronunciations). These various social features can be enabled by the mobile app 802 (e.g., to receive user input to initiate social interaction actions), the user backend 804 (e.g., to carry out social interaction actions), and the database 808 (e.g., to store social interaction data). A social interaction is an interaction with a social feature. A social interaction action is an action taken to effect the social interaction. Examples of social interactions include managing friends (e.g., managing followers, managing individuals followed), sharing stories (e.g., sharing individual stories, sharing chains of stories, sharing comments on stories, etc.), generating or managing posts (e.g., posts to the user's own feed or to a feed of another user), and the like.

The mobile app 802 can, in response to receiving input from the user to initiate a social interaction action, transmit a communication 810 to the user backend 804, which is an instruction to initiate a social interaction action.

Upon receiving the communication 810, the user backend 804 can carry out the social interaction action by sending communication 812 to a database 808 in which the social interaction data is stored. The social interaction action can result in a change to the database 808, such as to add new information (e.g., add a new post about a story), remove information (e.g., delete a selected story from a chain of stories), or otherwise modify information (e.g., replace a cover art image for a story with a different image). For example, a user initiating a social interaction that is adding a new individual as a “friend” on the platform can include adding an entry to the user's list of friends that contains an identifier of the new individual.

In some cases, the mobile app 802, user backend 804, and database 808 can be used to enable the generation and management of story chains.

In response to the mobile app 802 receiving input from a user to create and/or manage a story chain, the mobile app 802 can transmit a communication 814 to user backend 804 to create and/or manage a story chain.

Upon receiving the communication 814, the user backend 804 can send a communication 816 to the database 808 to take an action that results in the creation or management of a story chain. This communication 816 can include story chain information, such as an identifier for the story chain, a user-readable name for the story chain, a list of stories included on the story chain, a description of the story chain, an indication of one or more hosts associated with the story chain, and the like. When a story chain is created, the story chain information can be stored in the database 808. The database 808 can be accessed to access the story chain.

While described with certain features and communications, the social interaction workflow 800 and story chain management workflow 801 may each include additional, fewer, and/or different features and communications. For example, in some cases a user may instruct the system to auto-generate a description for a story chain containing multiple stories, in which case the user backend 804 may interact with and otherwise send communications to and receive communications from the AI backend 818 to automatically generate a description of the story chain. This description may be auto-generated by the AI backend 818 passing information about the stories within the story chain to an LLM generative AI, which can output a suitable description. In such cases, the user backend 804 or AI backend 818 may select a prompt template and generate a custom prompt specifically for generation of a story chain description.

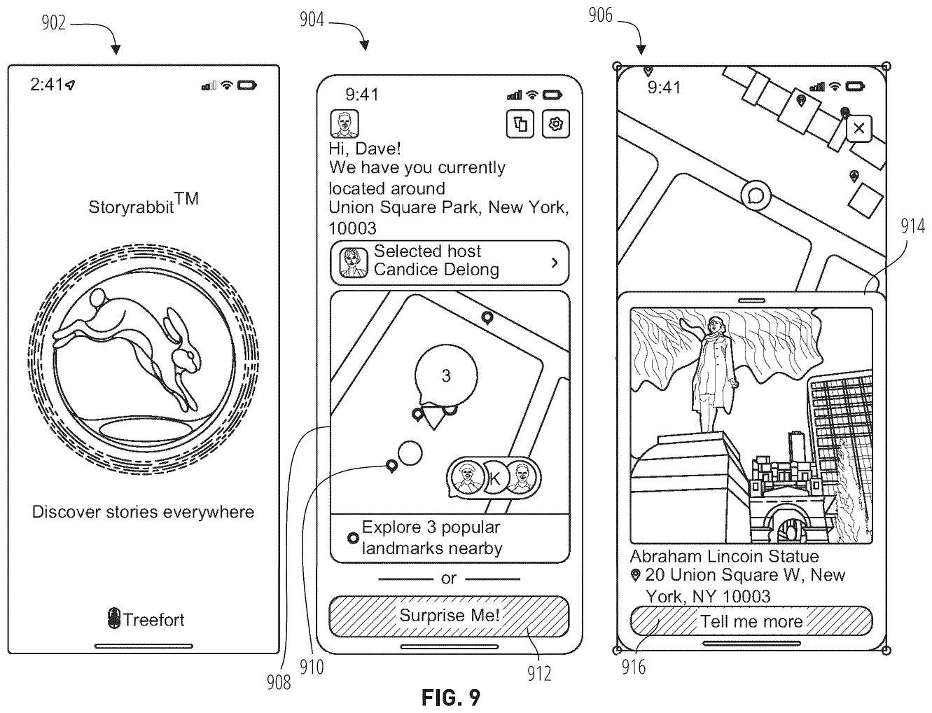

FIG. 9 is a set of screenshots depicting GUIs for general startup and POI selection, according to certain aspects of the present disclosure. The screenshots can be displayed on a user device (e.g., a smartphone). The GUIs can include a welcome screen 902, a home interface 904, and a POI interface 906.

The welcome screen 902 can present the user with information about the mobile app in general, such as a name, logo, and the like. In some cases, after presenting the welcome screen 902, the system can present the home interface 904.

The home interface 904 can present the user with various information and features, such as information about the current user, options to access user preferences, app settings, social interactions, and past stories. The home interface 904 can also include a map 908 (e.g., a map initially centered on the user's current location) that displays a number of POIs 910. In some cases, the POIs 910 displayed are a subset of all available nearby POIs after being filtered (e.g., filtered by currently selected host, which can also be displayed on the home interface 904). The home interface 904 may also include an auto-select button 912, here labeled “Surprise Me!” The user can interact with the home interface 904, such as by tapping on a POI 910 to select a particular POI for story generation or by tapping the auto-select button 912 to have a POI auto-selected for story generation.

Once a POI is selected, the mobile app can present a POI interface 906. The POI interface 906 can present information about a particular POI in a POI information screen 914. The POI information screen 914 can include information such as an image or video of the POI, a name of the POI, an address of the POI, and/or other such information). The POI information screen 914 can also include a more information button 916, which can be pressed by the user to generate a story for the user based on the POI.

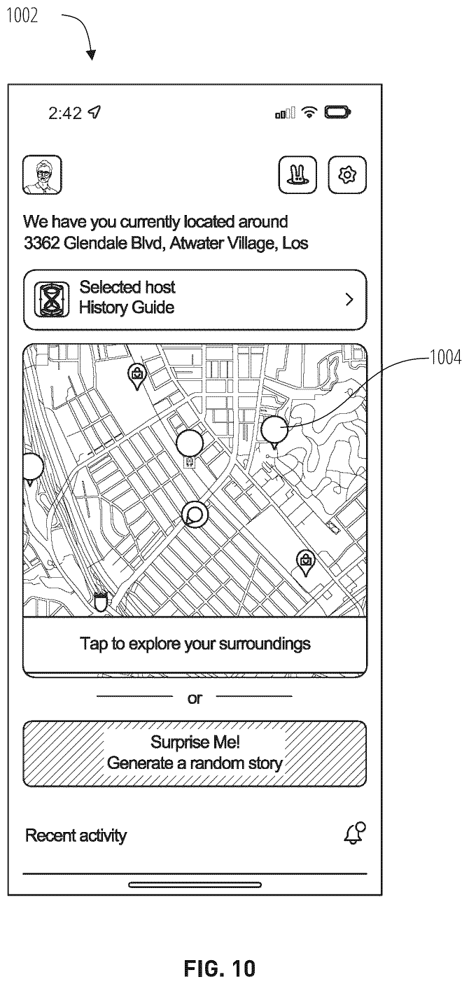

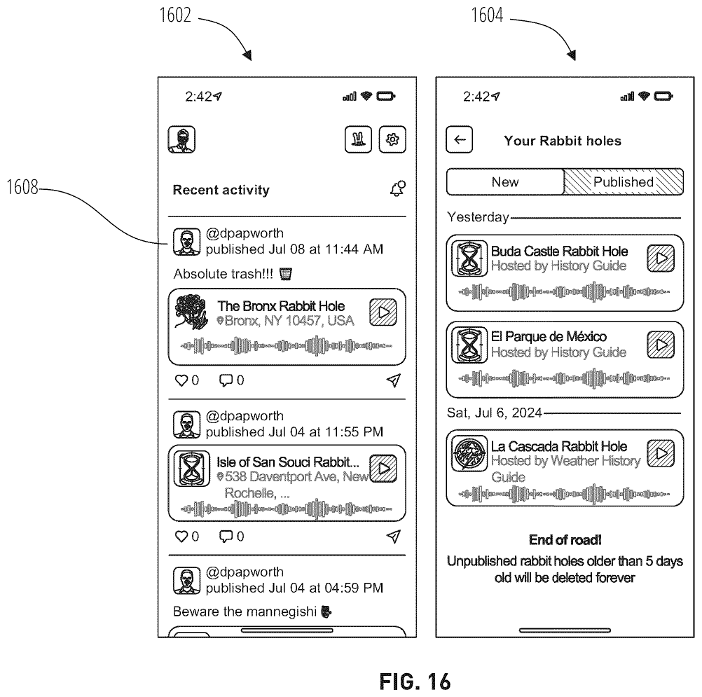

FIG. 10 is a screenshot depicting an alternate GUI for POI selection, according to certain aspects of the present disclosure. The screenshots can be displayed on a user device (e.g., a smartphone). The GUI can include a home interface 1002 that is an alternate version of the home interface 904 of FIG. 9. In addition to various design differences, the home interface 1002 includes a POI indicator 1004 that takes the form of a rabbit logo. This unique POI indicator 1004 can help differentiate selectable POIs from other POIs that may otherwise appear on the map (e.g., nearby stores, metro stops, etc.). The home interface 1002 can also include a recent activity section as described in further detail in FIG. 16.

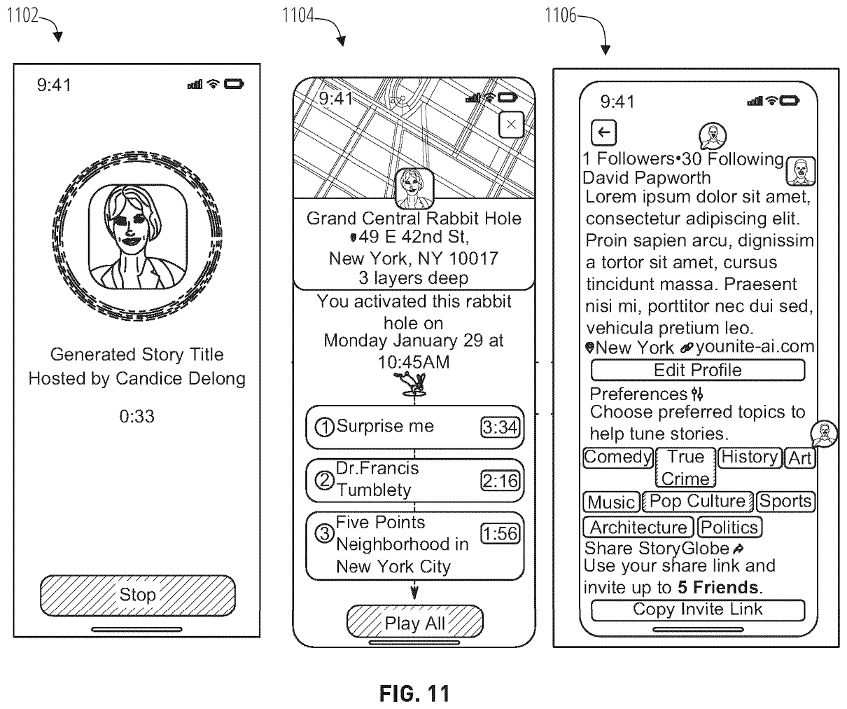

FIG. 11 is a set of screenshots depicting GUIs for story playback, activity information, and user preferences, according to certain aspects of the present disclosure. The screenshots can be displayed on a user device (e.g., a smartphone). The GUIs can include a player interface 1102, an activity interface 1104, and a preference interface 1106.

Once a story is generated, it can be presented to a user, such as via a player interface 1102. The player interface 1102 can show an image associated with the story (e.g., an image of the host narrating the story). The player interface 1102 can display a title associated with the story, which can be generated as part of the generated story content (e.g., generated as part of or along with the story transcript). The player interface 1102 can display narrator information, such as a name and/or image of the narrator. The player interface 1102 can display a user's progress in the story, such as by displaying a count-up or count-down timer, displaying a progress bar, or otherwise providing information to the user about the progress within the story. In some cases, the player interface 1102 can display an indicator that the story audio content is being played, which in some cases can be a changing count-up or count-down timer. In some cases, the player interface 1102 can include controls to control story playback, such as a stop button, a pause button, a speed control (e.g., to slightly increase or decrease playback speed), and the like. Other features can be used on the player interface 1102.

After a story is presented, the user can be presented with an activity interface 1104. The activity interface 1104 can show the story that was just completed, optionally also showing previously completed stories, and can then show one or more follow-up prompts. As depicted in FIG. 11, the follow-up prompts can take the form of an ordered list of stories from which the user can select an individual story for playback or can select a “play all” option to play through all stories in the order of the ordered list. As depicted in FIG. 11, the first follow-up option is a “surprise me” story that has been or will be auto-generated by the platform; the second follow-up prompt is shown as a story about an individual associated with a POI (e.g., such as an individual mentioned in the recently-presented story or in an earlier story on the ordered list); and the third follow-up prompt is shown as a story about a location.

When a user wishes to set up their user preferences, they can access a preference interface 1106. The preference interface 1106 can show and permit editing of the user's profile, which can be displayed to others as part of the social features of the platform. The preference interface 1106 can allow the user to set various user preferences, such as selecting their desired genres or topics, selecting their desired hosts, and the like. These user preferences can be especially useful in automatically generating stories (e.g., through a POI auto-select feature).

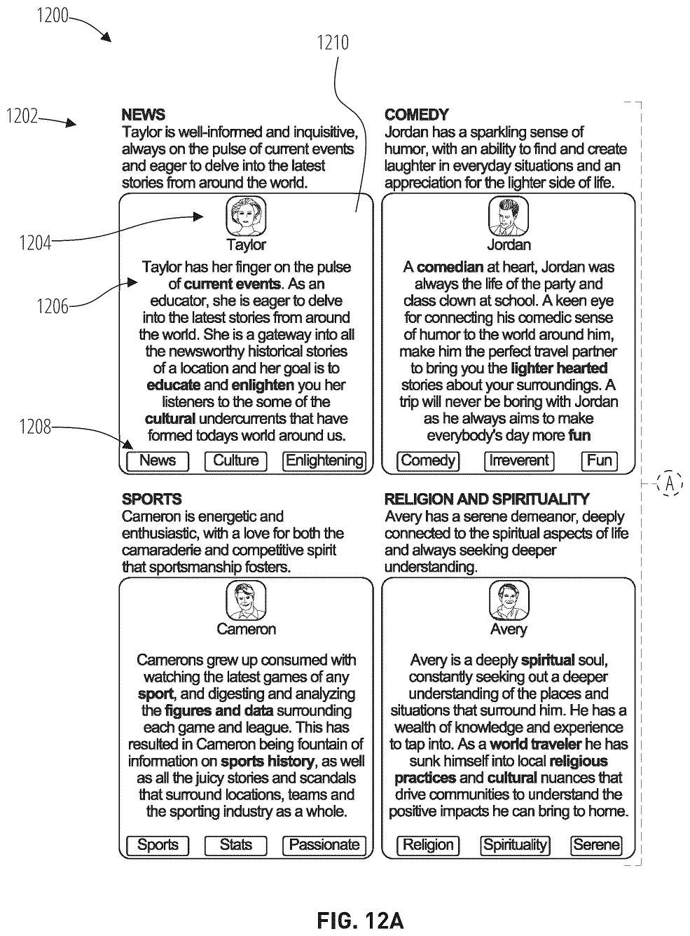

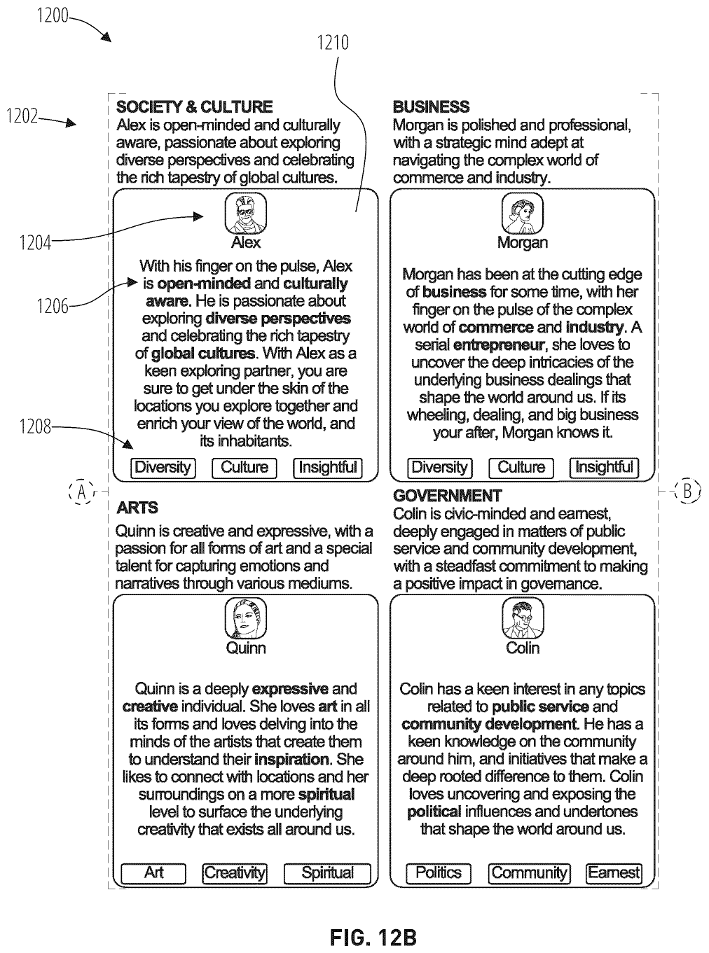

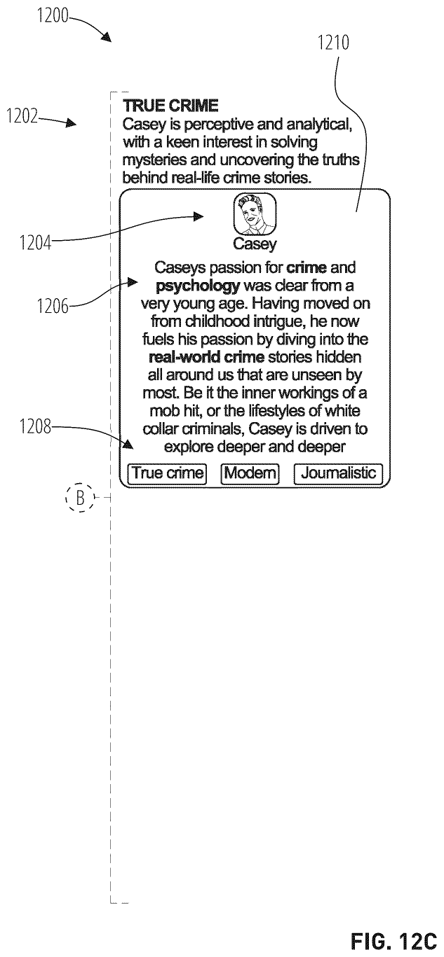

FIGS. 12A-12C are portions of a diagram depicting available story hosts, according to certain aspects of the present disclosure. The diagram depicts host options 1200, which may include all possible hosts or a subset of available hosts (e.g., filtered by language or genres).

Each host can be presented with topic information 1202 and a host information card 1210. The topic information 1202 can include information about a topic or primary genre associated with the host and a general description of that topic/genre.

The host information card 1210 can include various information about the user themselves, such as a host image 1204, a host description 1206, and host tags 1208. The host description 1206 can provide information about the host, which can inform a user as to how that host is likely to present information. Additionally, host tags 1208 can identify genres and sub-genres associated with the host, including those other than the primary genre associated with the host. For example, a host may be primarily associated with news, but may also be associated with culture and engineering. In some cases, host tags 1208 can include tags other than just genres or sub-genres.

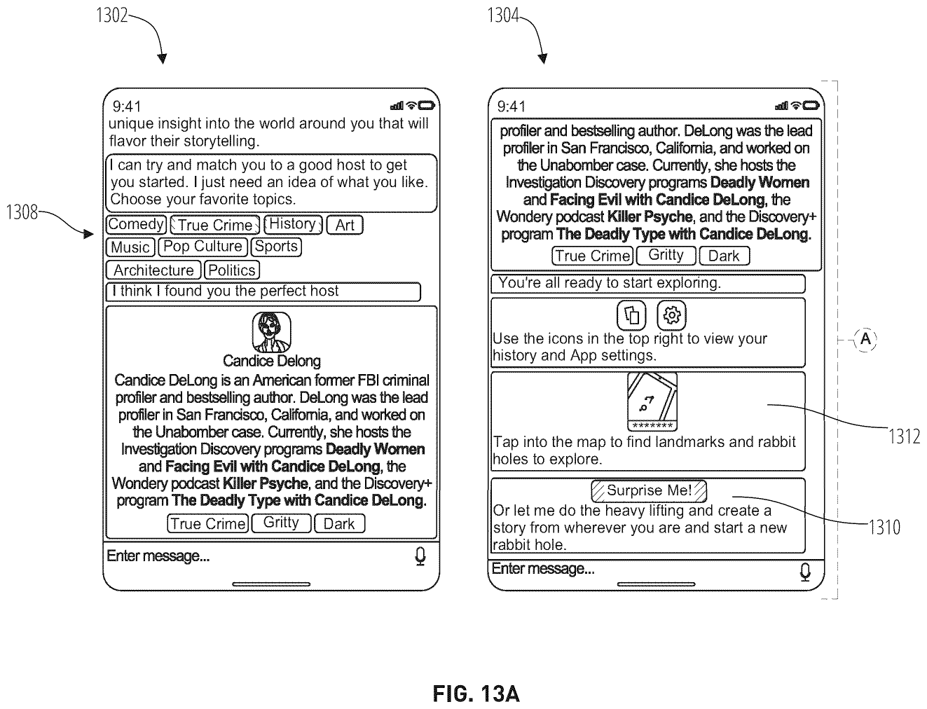

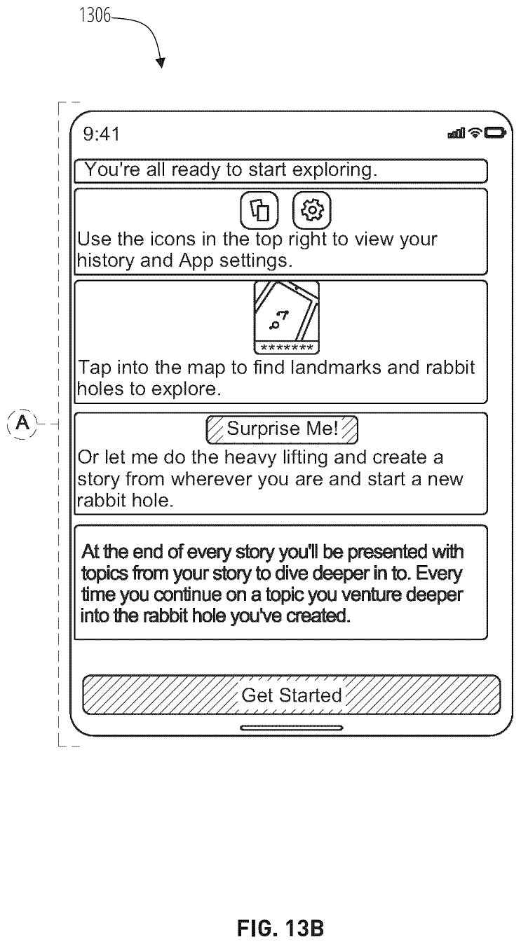

FIGS. 13A-13B are a set of screenshots depicting GUIs for host selection and initial POI selection, according to certain aspects of the present disclosure. The screenshots can be displayed on a user device (e.g., a smartphone). The GUIs can include a host suggestion interface 1302, a selection interface 1304, and a start interface 1306.

The system can help the user select a desired host. A selection interface 1304 can be presented, giving the user an option to select various options 1308 (e.g., desired genres) that are of interest to the user. The system can then take the user's selected options, and optionally other user preference information, and identify a particular host who may be a good fit for the user (e.g., matches the most of the user's options).

In some cases, after a host is selected, the system can provide a prompt to select a POI for story generation via a selection interface 1304. The selection interface 1304 can provide the user with a map option 1310 and an auto-select option 1312. Upon selecting the map option 1310, a user may be presented with a map showing various potential POIs, each of which can be selected by the user for story generation. Upon selecting the auto-select option 1312, the system can automatically identify a POI from which to generate a story.

After a POI has been selected, the system can present a start interface 1306. The start interface 1306 can include a start button which can be engaged by the user to commence playback of the story. In some cases, the start interface 1306 can include additional information of interest to the user, such as information about how the user will be presented with one or more follow-up prompts upon completion of the story.

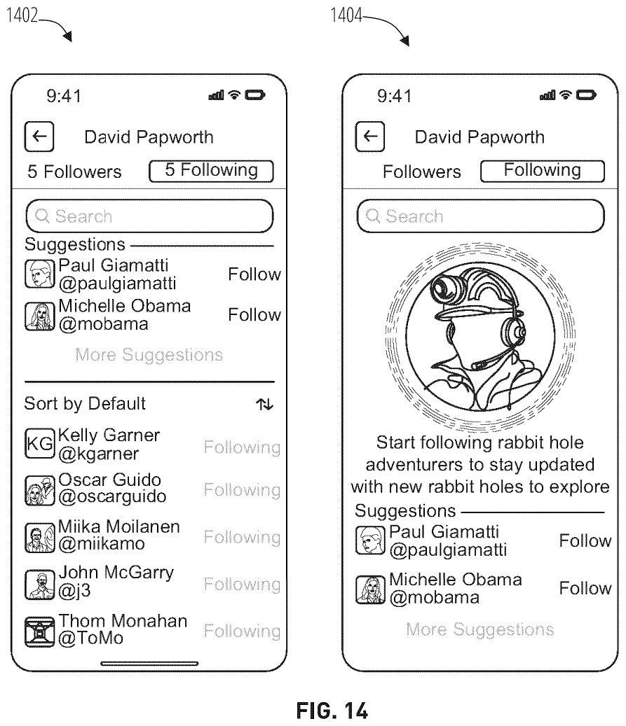

FIG. 14 is a set of screenshots depicting GUIs for social interactions, according to certain aspects of the present disclosure. The screenshots can be displayed on a user device (e.g., a smartphone). The GUIs can include a social interface 1402 and a social interface 1404.

The social interface 1402 can show social interaction information associated with the user, such as individuals they are currently following, individuals the user may be interested in following, and individuals following the user. The social interface 1402 can give the user options to follow and unfollow users, as well as other options.

In some cases, such as if the user is not yet following anyone, the social interface 1404 can be presented showing individuals they may be interested in following.

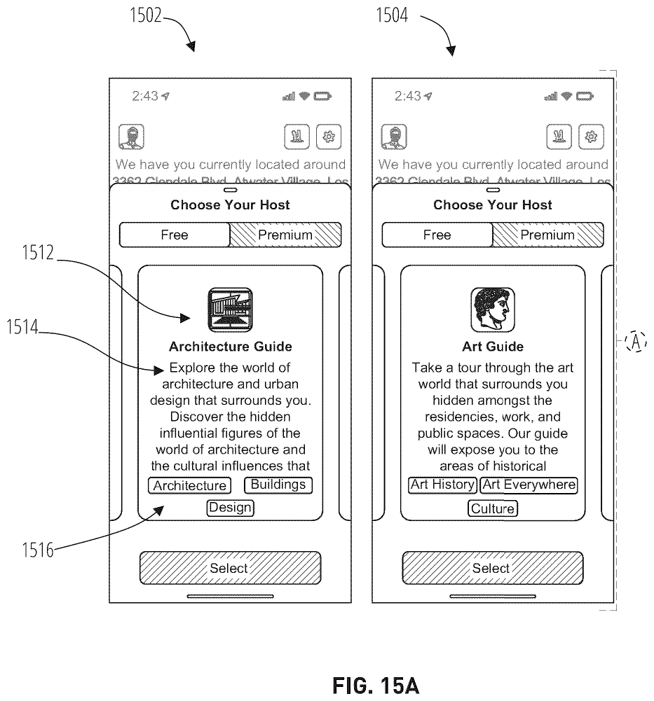

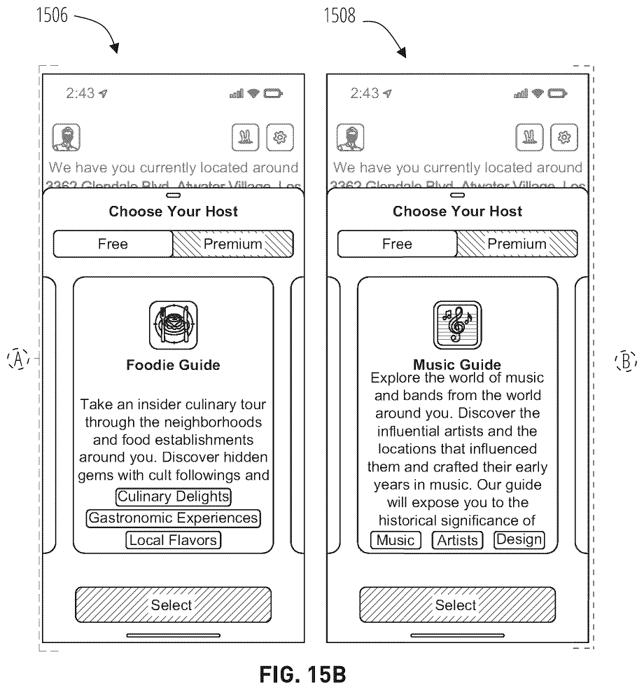

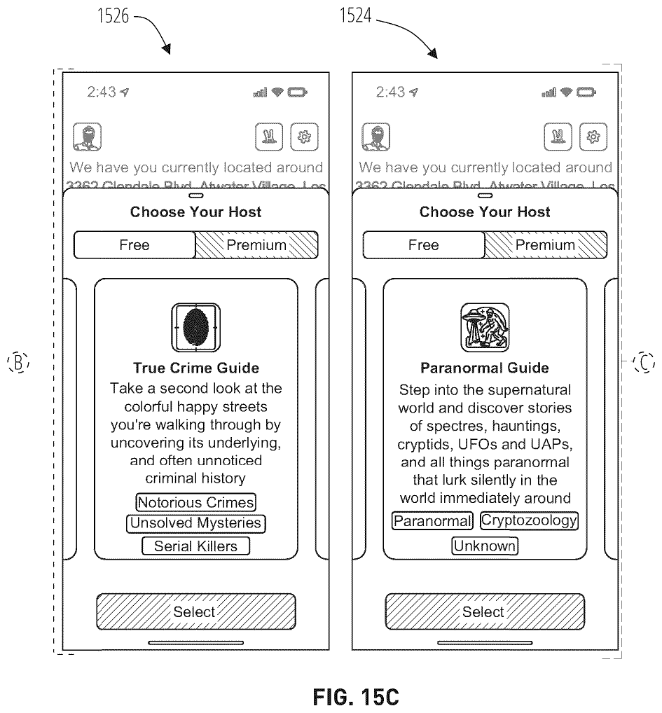

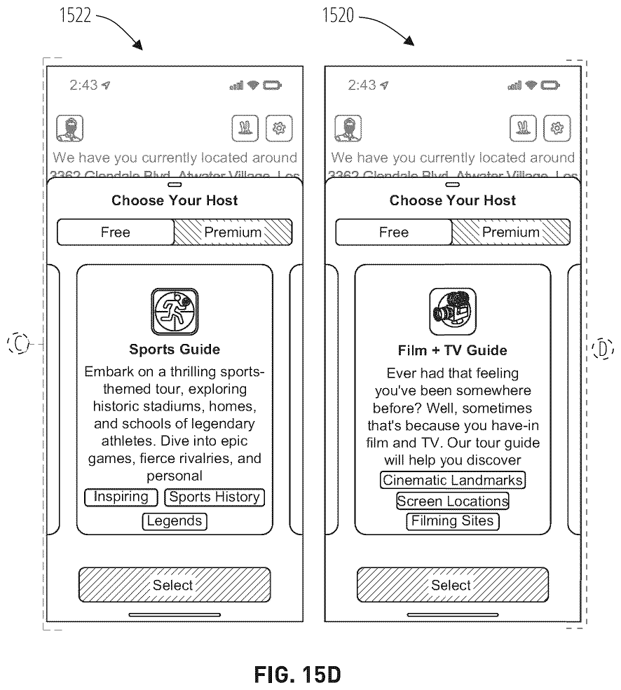

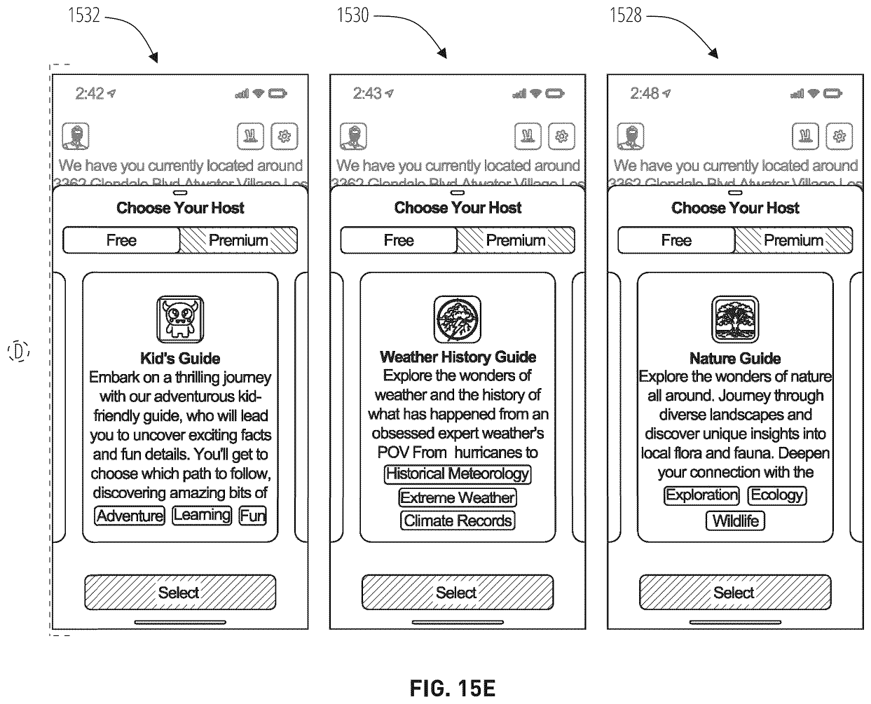

FIGS. 15A-15E are sets of screenshots depicting GUI screens for story host selection, according to certain aspects of the present disclosure. In some cases, selecting a host can include selecting a genre. The screenshots can be displayed on a user device (e.g., a smartphone). Information can be provided for each host, such as via a host-specific selection screen, although that need not always be the case.

In an example, on an adventure guide host screen 1502, the user can be presented with a host name 1512 (e.g., “Architecture Guide”), a host description 1514 (e.g., “Explore the world of architecture and urban design that surrounds you. Discover the hidden influential figures of the world of architecture and the cultural influences that inspire them. Our guide will expose you to the historical significance of notable buildings and urban spaces to help you understand and look more closely at your surroundings”), one or more host tags 1516 (e.g., “Architecture,” “Buildings,” “Design”). In some cases, other information can be provided. When selected, the story to be generated can be generated using a prompt template associated with the given genre (e.g., “Architecture Guide”) and a voice predetermined to be associated with that host (e.g., a particular voice identifier used for the Architecture Guide or a selection from a limited list of voice identifiers used for the Architecture Guide).

Examples of free hosts can include an adventure guide host (e.g., via adventure guide host screen 1502), an art guide host (e.g., via art guide host screen 1504), a foodie guide host (e.g., via foodie guide host screen 1506), a music guide host (e.g., via music guide host screen 1508), a true crime guide host (e.g., via true crime guide host screen 1526), a paranormal guide host (e.g., via paranormal guide host screen 1524), a sports guide host (e.g., via sports guide host screen 1522), a film and TV guide host (e.g., via film and TV guide host screen 1520), a kid's guide host (e.g., via kid's guide host screen 1532), a weather history guide host (e.g., via weather history guide host screen 1530), and a nature guide host (e.g., via nature guide host screen 1528). Other hosts can be included additionally or instead of those hosts depicted in FIGS. 15A-15E.

In some cases, a user can select between free hosts and premium hosts. As depicted in FIGS. 15A-15E, the free or premium host selection is currently set to “Free”,” Free hosts may be freely available to all users, whereas access to premium hosts may be provided only to users with requisite permissions, such as users that have purchased access to premium hosts, users who pay a subscription fee, users who have participated with the platform (e.g., used the platform generally and/or socially shared content via or from the platform) a requisite amount, users provided with an access code to access one or more specific premium hosts (e.g., access to premium hosts associated with a movie may be provided through use of an access code given to individuals who purchased tickets to see the movie), and users who are part of a particular group (e.g., members of an organization may be provided with access to premium hosts associated with that organization).

In some cases, a premium host can be associated with the same genre as a free host (e.g., a free host version of “Architecture Guide” and a premium host version of “Architecture Guide”). In some cases, the free host version may be a generic guide whereas the premium version is a guide for the same genre, but based on a specific person, whether real or fictional. In an example, for the true crime genre, the free host version may be a generic true crime guide, whereas the premium version may be based on Candice DeLong, a former FBI criminal profiler, best-selling author, and popular podcaster.

In some cases, the list of premium hosts can include additional genres other than those available in the list of free hosts. For example, the list of free hosts can include a Cynical Guide, a Monster Guide, A Fantasy Guide, and an ASMR (autonomous sensory meridian response) Guide. In some cases, a premium guide can be based on a specific person or persona, whether real or fictional.

The various hosts discussed with reference to FIGS. 15A-15E can be the same or similar to hosts and/or topics as discussed with reference to FIGS. 12A-12C.

FIG. 16 is a set of screenshots depicting GUIs for social interaction, according to certain aspects of the present disclosure. The screenshots can be displayed on a user device (e.g., a smartphone). The GUIs can include a social activity screen 1602 and a past stories screen 1604.

The social activity screen 1602 can include a listing of social activity in the form of social activity entries 1608. In some cases, the social activity screen 1602 is designed to show only recent social activity of the user themselves, such as entry social activity entries 1608 published by the user viewing the social activity screen 1602. In some cases, the social activity screen 1602 can show recent social activity of a selected user (e.g., another user). In some cases, the social activity screen 1602 can show the recent social activity of anyone that the given user is following (e.g., multiple other users).

Each social activity entry 1608 can provide information about a story associated with the user who published the social activity entry 1608, such as (i) a story that user recently completed; (ii) a story that user recently started listening to; (iii) a story that user selected to publish; or (iv) any combination of (i)-(iii).

In some cases, each social activity entry 1608 can be associated specifically a story whose generation was initiated at the publishing user's request (e.g., the user selected the host and POI, or the user engaged an auto-select feature), although that need not always be the case. In some cases, the recent activity can include a social activity entry 1608 that is based on a story whose generation was initiated by another user, such as a story previously published by another user but listened to (and optionally further shared) by the currently publishing user.

The social activity entry 1608 can include information about the story, such as a title (e.g., a user-provided or auto-generated title), a POI information (e.g., a name or location), host information (e.g., a genre, voice, etc.), timestamp information (e.g., timestamp information for generation of the story; timestamp information for when the user listened to the story; and/or timestamp information for when the user published the social activity entry 1608), and the like. In some cases, each social activity entry 1608 can give an option for another user to engage with the social activity entry 1608, such as by liking (e.g., clicking a heart icon), commenting on (e.g., by clicking a speech bubble icon), or sharing (e.g., by clicking on a paper airplane icon) the story and/or social activity entry 1608. In some cases, the social activity entry 1608 includes an indication of the user who published the social activity entry 1608.

The past stories screen 1604 can show a listing of a user's own past stories, which can include stories that have been generated and/or stories to which the user has listened or started to listen. In some cases, the user can select a story to listen to it again and/or to share or publish the stories (e.g., share or publish to their social activity feed, such as to appear on the social activity screen 1602 of other users who follow the given user). In some cases, the past stories screen 1604 can provide a filter to filter out stories in the list, such as to show only “new” stories or to show only “published” stories.

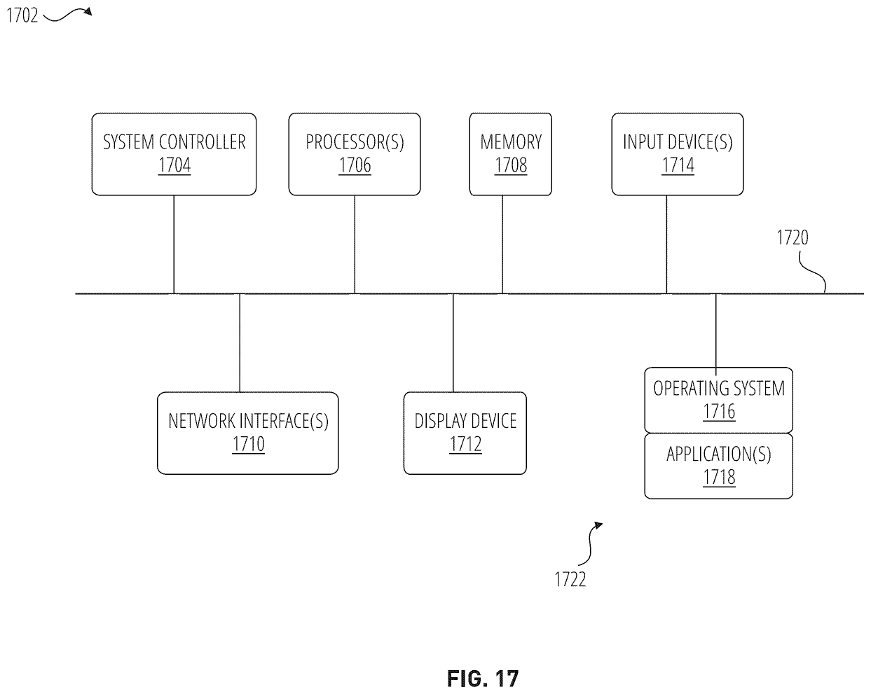

FIG. 17 is a block diagram of an example system architecture 1702 for implementing features and processes of the present disclosure, such as those presented with reference to processes 200, 300, 400, and 500 of FIGS. 2, 3, 4, and 5, respectively. The features and processes disclosed herein can be implemented using one or multiple instances of 1702. The system architecture 1702 can be used to implement a server (e.g., a cloud-accessible server), a user device (e.g., a smartphone or personal computer), or any other suitable device for performing some or all of the aspects of the present disclosure. The system architecture 1702 can be implemented on any electronic device that runs software applications derived from compiled instructions, including without limitation personal computers, servers, smart phones, electronic tablets, game consoles, email devices, and the like. In some implementations, the system architecture 1702 can include one or more processors 1706, one or more input devices 1714, one or more display devices 1712, one or more network interfaces 1710, and one or more computer-readable media 1722. Each of these components can be coupled by bus 1720.

Display device 1712 can be any known display technology, including but not limited to display devices using Liquid Crystal Display (LCD) or Light Emitting Diode (LED) technology. Processor(s) 802 can use any known processor technology, including but not limited to graphics processors and multi-core processors. Input device 1714 can be any known input device technology, including but not limited to a keyboard (including a virtual keyboard), mouse, track ball, and touch-sensitive pad or display. In some cases, audio inputs can be used to provide audio signals, such as audio signals of an individual speaking. Bus 1720 can be any known internal or external bus technology, including but not limited to ISA, EISA, PCI, PCI Express, NuBus, USB, Serial ATA or Fire Wire.

Computer-readable medium 1722 can be any medium that participates in providing instructions to processor 1706 for execution, including without limitation, non-volatile storage media (e.g., optical disks, magnetic disks, flash drives, etc.) or volatile media (e.g., SDRAM, ROM, etc.). The computer-readable medium (e.g., storage devices, mediums, and memories) can include, for example, a cable or wireless signal containing a bit stream and the like. However, when mentioned, non-transitory computer-readable storage media expressly exclude media such as energy, carrier signals, electromagnetic waves, and signals per se.

Computer-readable medium 1722 can include various instructions for implementing operating system 1716 and applications 1718 such as computer programs. The operating system 1716 can be multi-user, multiprocessing, multitasking, multithreading, real-time and the like. The operating system 1716 performs basic tasks, including but not limited to: recognizing input from input device 1714; sending output to display device 1712; keeping track of files and directories on computer-readable medium 1722; controlling peripheral devices (e.g., storage drives, interface devices, etc.) which can be controlled directly or through an I/O controller; and managing traffic on bus 1720. Computer-readable medium 1722 can include various instructions for implementing firmware processes, such as a BIOS. Computer-readable medium 1722 can include various instructions for implementing any of the processes described herein, including at least processes 200, 300, 400, and 500 of FIGS. 2, 3, 4, and 5, respectively.

Memory 1708 can include high-speed random access memory and/or non-volatile memory, such as one or more magnetic disk storage devices, one or more optical storage devices, and/or flash memory (e.g., NAND, NOR). The memory 1708 (e.g., computer-readable storage devices, mediums, and memories) can include a cable or wireless signal containing a bit stream and the like. However, when mentioned, non-transitory computer-readable storage media expressly exclude media such as energy, carrier signals, electromagnetic waves, and signals per se. The memory 1708 can store an operating system, such as Darwin, RTXC, LINUX, UNIX, OS X, WINDOWS, or an embedded operating system such as VxWorks.

System controller 1704 can be a service processor that operates independently of processor 1706. In some implementations, system controller 1704 can be a baseboard management controller (BMC). For example, a BMC is a specialized service processor that monitors the physical state of a computer, network server, or other hardware device using sensors and communicating with the system administrator through an independent connection. The BMC is configured on the motherboard or main circuit board of the device to be monitored. The sensors of a BMC can measure internal physical variables such as temperature, humidity, power-supply voltage, fan speeds, communications parameters and operating system (OS) functions.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computing system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an application programming interface (API). An API can define one or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, and the like.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art. Numerous changes to the disclosed embodiments can be made in accordance with the disclosure herein, without departing from the spirit or scope of the disclosure. Thus, the breadth and scope of the present disclosure should not be limited by any of the above described embodiments.

Although certain aspects and features of the present disclosure have been illustrated and described with respect to one or more implementations, equivalent alterations and modifications will occur or be known to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application.

The terminology used herein is for the purpose of describing particular embodiments only, and is not intended to be limiting of the disclosure. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

One or more elements or aspects or steps, or any portion(s) thereof, from one or more of any of the claims below can be combined with one or more elements or aspects or steps, or any portion(s) thereof, from one or more of any of the other claims below or combinations thereof, to form one or more additional implementations and/or claims of the present disclosure.

1. A computer-implemented method, comprising:
receiving location information associated with a user;
identifying one or more points of interest (POIs) based at least in part on the location information;
receiving a story host selection;
dynamically generating story content based at least in part on the identified one or more POIs and the story host selection, wherein dynamically generating the story content includes:
generating a story transcript based at least in part on the identified one or more POIs, generating the story transcript including:
preparing a custom prompt based at least in part on the identified one or more POIs;
passing the custom prompt to a large language model (LLM) generative artificial intelligence (AI); and
receiving an AI response from the LLM generative AI, the story transcript being based at least in part on the AI response;
generating story audio content based at least in part on the story transcript and the story host selection, the story host selection being indicative of a selected voice out of a plurality of available voices for generation of audio content from text, the story audio content being generated using the selected voice; and
providing the story content for presentation to the user, wherein providing the story content to the user includes initiating playback of the generated story audio content.

2. (canceled)

3. The computer-implemented method of claim 1, wherein generating the story transcript is further based at least in part on the story host selection, the story host selection being indicative of a story theme, and wherein preparing the custom prompt is further based at least in part on the story theme.

4. The computer-implemented method of claim 1, wherein the story host selection is indicative of a voice identifier,
wherein generating the story audio content includes:
passing the voice identifier and the story transcript to an artificial intelligence (AI) audio synthesis engine, the voice identifier being indicative of the selected voice; and
receiving synthesized audio in response to passing the voice identifier and the story transcript, the story audio content being based at least in part on the synthesized audio.

5. (canceled)

6. The computer-implemented method of claim 1, wherein preparing the custom prompt is further based at least in part on one or more preferences associated with the user.

7. The computer-implemented method of claim 1, wherein preparing the custom prompt includes selecting a prompt template from a plurality of prompt templates, and wherein the custom prompt is based at least in part on the selected prompt template.

8. The computer-implemented method of claim 1, wherein the location information includes a location name, and wherein preparing the custom prompt is further based at least in part on the location name.

9. The computer-implemented method of claim 1, further comprising identifying one or more advertisement vendors associated with the location information or the one or more POIs, wherein preparing the custom prompt is based at least in part on the one or more advertisement vendors such that the AI response includes content associated with the one or more advertisement vendors.

10. The computer-implemented method of claim 1, further comprising identifying one or more advertisements associated with the location information or the one or more POIs, wherein generating the story transcript includes combining the one or more advertisements with at least a portion of the AI response to create the story transcript.

11. (canceled)

12. The computer-implemented method of claim 4, further comprising identifying one or more audio advertisements associated with the location information or the one or more POIs, wherein generating the story audio content includes combining the one or more audio advertisements with at least a portion of the synthesized audio to create the story audio content.

13. The computer-implemented method of claim 1, wherein receiving the location information includes:
receiving GPS coordinates associated with a user device of the user; and
determining the location information based at least in part on the GPS coordinates.

14. The computer-implemented method of claim 1, where identifying the one or more POIs includes receiving a user POI selection indicative of at least one POI of the one or more POIs.

15. The computer-implemented method of claim 1, further comprising receiving one or more camera images associated with a user device of the user, wherein identifying the one or more POIs is based at least in part on the one or more camera images.

16. The computer-implemented method of claim 1, further comprising storing the dynamically generated story content for later use.

17. The computer-implemented method of claim 16, further comprising generating a shareable URL associated with the stored story content, wherein the URL, when accessed by an additional user, causes the stored story content to be provided to the additional user.

18. The computer-implemented method of claim 1, wherein providing the story content for presentation to the user includes providing one or more follow-up prompts for presentation to the user following presentation of the story content.

19. A system comprising:
a control system including one or more processors; and
a memory having stored thereon machine readable instructions;
wherein the control system is coupled to the memory, and the method of claim 1 is implemented when the machine executable instructions in the memory are executed by at least one of the one or more processors of the control system.

20. A computer program product embodied on a non-transitory computer-readable medium and comprising instructions which, when executed by a computer, cause the computer to carry out the method of claim 1.

21. The computer-implemented method of claim 7, wherein selecting the prompt template from the plurality of prompt templates is based at least in part on the story host selection, the story host selection being indicative of the selected prompt template.

22. The computer-implemented method of claim 1, wherein passing the custom prompt to the LLM generative AI includes passing the custom prompt via an application programming interface (API) associated with the LLM generative AI.

23. The computer-implemented method of claim 1, wherein generating the story audio content includes passing the story transcript to an audio synthesis engine, wherein the audio synthesis engine is an AI-based text-to-speech engine, the AI-based text-to-speech engine being trained on human voices such that, when provided with input text, the AI-based text-to-speech engine outputs audio data representative of human-like speech.
